(19) United States
(12) Patent Application Publication
(10) Pub. No.: US 2005/0276263 A1
(43) Pub. Date: Dec. 15, 2005

(54) Traffic distribution control device

(76) Inventors: Takahiro Suetsugu, Yokohama (JP); Hiroshi Kinoshita, Yokohama (JP); Makoto Yoshimi, Yokohama (JP)

Correspondence Address: KATTEN MUCHIN ROSENMAN LLP, 575 MADISON AVENUE, NEW YORK, NY, 10022-2585, US

(21) Appl. No.: 10/978,969

(22) Filed: Nov. 1, 2004

(30) Foreign Application Priority Data
Jun. 15, 2004 (JP) JP2004-176938

(51) Int. Cl. H04L 1/00; H04J 3/14; H04J 1/16; H04L 12/26; H04L 12/28; H04L 12/56

(52) U.S. Cl. 370/389; 370/252

(57) ABSTRACT

A data transmission device 10 serving as a traffic distribution control device is a device which, in order to distribute traffic across a plurality of physical ports composing a logical port for link aggregation, uses a hash function to calculate a hash value from a destination address and a source address of a receive packet, and determines a destination physical port. The traffic distribution control device includes a measuring unit 13 that measures an output flow rate of a packet outputted from each of the plurality of physical ports; a calculating unit 14 that calculates a flow rate ratio between the plurality of physical ports with respect to the measured output flow rates; and a first control unit 12 that feeds the calculated flow rate ratio back to a bandwidth distribution ratio between the plurality of physical ports to change numerical allocation of hash values for determining the destination physical port.

### BACKGROUND OF THE INVENTION

The present invention relates to a traffic distribution control technology for link aggregation used in a data transmission device for a communication carrier (communication provider) that provides a wide-area LAN (Local Area Network) service etc. or another such device.

In the case of building a private network that allows an enterprise to connect multiple nodes, there are generally adopted a method of building a private network by using a dedicated line, a method of building a private network by an IP-VPN (Virtual Private Network) using an IP (Internet Protocol), and a method of building a private network by a wide-area LAN service using a VLAN (Virtual Local Area Network).

Among those building methods, the method by the wide-area LAN service, which allows the building with a layer 2 switch device, requires lower cost and easier management than the method by using the dedicated line or the method by the IP-VPN, thereby showing a significant increase in number at present. FIG. 1 shows an example of a wide-area LAN service system using a VLAN. Denoted by a reference numeral 10 in an arrangement of the wide-area LAN service system is a layer 2 switch device serving as a data transmission device for a communication carrier.

The wide-area LAN service must handle various client demands, mainly in order to connect enterprise LANs to each other, by allowing a packet flow rate obtained not only in a 100 Mbps or 1 Gbps line (link) but also at a data transmission rate of, for example, 200 Mbps or 300 Mbps or by other such means. In order to solve this, attentions have been focused on link aggregation that bundles a plurality of physical ports (physical links) to handle the physical ports as a virtually single link (logical link)

The link aggregation defined by IEEE 802.3ad is a technology in which, between opposing devices (layer 2 switch devices) that are directly connected to each other, a plurality of physical ports of each Ethernet interface (Ethernet: registered trademark) are bundled to make the physical ports recognized as a logical port being logically single. By bundling the plurality of physical ports, it is possible to increase a bandwidth of the logical port (transmission bandwidth), while on the other hand, redundancy is maintained.

The term “physical port” as used herein refers to a port that is physically provided for Gigabit Ethernet (Ethernet: registered trademark), Fast Ethernet (Ethernet: registered trademark), or the like. The term “logical port” refers to a virtual port that is obtained by bundling a plurality of physical ports and serves as a unit of the link aggregation.

For example, in the case where a user usable bandwidth is provided at 400 Mbps for connection between layer 2 switch devices (devices 1 and 2) shown in FIG. 2, the physical port for 100-Mbps Fast Ethernet (Ethernet: registered trademark) has a shortage of bandwidth by 300 Mbps, and the physical port for 1-Gbps Gigabit Ethernet (Ethernet: registered trademark) has a waste of bandwidth by 600 Mbps. According to the link aggregation, 4 physical ports for 100-Mbps Fast Ethernet (Ethernet: registered trademark) are bundled into a single logical port to thereby secure the bandwidth at 400 Mbps. Further, even if part of the physical ports composing the logical port experiences a failure, the remaining physical port(s) can maintain communication. For example, even when one of the 4 physical ports composing the logical port experiences a failure, the communication at a bandwidth of 300 Mbps is allowed.

In the link aggregation, in order to distribute traffic evenly across a plurality of physical ports composing a logical port, a hash function is used to calculate a hash value from a destination address and source address of a receive packet and determine a destination port (physical port). Accordingly, in the current link aggregation, the destination port is determined based on the destination address and the source address, and some traffic may not be distributed depending on the destination address and the source address and cannot avoid being forwarded to the same port.

The term “hash function” as used herein refers to a function (procedure) for summarizing a list of documents or character strings into a predetermined length of data, and a value that is outputted through the function is referred to as a hash value or simply as a hash.

For example, as shown in FIG. 3, the hash value outputted by the hash function is set as the remainder obtained by dividing the sum of a destination MAC address (DA) and a source MAC address (SA) by the number (N) of physical ports. Here, since there exist physical ports P1, P2, and P3, the number of physical port N=3. The packet flow rates from a terminal, which is included in a LAN 1 and has a source MAC address SA(A): 00-E0-00-00-11-01, to terminals, which are included in a LAN 2 and respectively have destination MAC addresses DA(X): 00-E0-00-00-11-02, DA(Y): 00-E0-00-00-11-03, and DA(Z): 00-E0-00-00-11-04, are set to be the same rates (DA(X): 10 Mbps, DA(Y): 10 Mbps, DA(Z): 10 Mbps) Further, the packet flow rates from a terminal, which is included in the LAN 1 and has a source MAC address SA(B): 00-E0-00-00-11-05, to the terminals, which are included in the LAN 2 and respectively have the destination MAC addresses DA(X), DA(Y), and DA(Z), are set to be the same rates (DA(X): 10 Mbps, DA(Y): 10 Mbps, DA(Z) 10 Mbps).

As shown in FIG. 4, packets outputted from the layer 2 switch device (device 1) are distributed evenly across the physical ports P1, P2, and P3. However, as shown in FIG. 5, the packet flow rates from the source MAC address SA (A) to the destination MAC addresses DA(X), DA(Y), and DA(Z) are set to DA(X): 20 Mbps, DA(Y): 5 Mbps, and DA(Z): 5 Mbps, respectively, and the packet flow rates from the source MAC address SA(B) to the destination MAC addresses DA(X), DA(Y), and DA(Z) are set to DA(X): 5 Mbps, DA(Y): 5 Mbps, and DA(Z): 20 Mbps, respectively. Then, the packet flow rates exhibit an imbalance, which causes a problem in that the packets concentrate on the physical port P1.

Meanwhile, control of bandwidth assurance (QoS: Quality of Service) in the link aggregation is performed on each of the physical ports composing the logical port, which leaves a problem in that the QoS is not assured for the overall bandwidth of the logical port. Therefore, a contracted bandwidth (for example, 30 Mbps) needs to be allocated to each contractor (user) to all physical ports configuring the link aggregation (see FIG. 6).

In order to solve this, in addition to a conventional method of performing QoS control on each virtual path that constitutes a physical port, there exists a technology in which QoS control is performed on each bundle of virtual paths by monitoring the total amount of communication traffic through virtual paths on a virtual path bundle basis, and comparing a preset threshold and the total sum of the number of cells that reached the virtual path bundle (see Patent document 1).

In this technology, the total sum of the number of cells that have reached the virtual path bundle is monitored in ATM communication, and the total sum of the number of cells that have reached a plurality of virtual paths within a predetermined time period is measured. Also, a preset threshold value, which is previously set based on a contract, is stored, and the threshold value and the measured value are compared. Even though cell discard is controlled according to comparison results, the cell discard may still fall behind, and the total sum of the number of cells that have reached the virtual path bundle may breach the contract of a maximum usable bandwidth. Patent document 1 describes that, in that case, all the virtual paths received in a device owned by the corresponding subscriber may be blocked (see FIG. 7).

The conventional technology described above raises the following two problems.

(1) Even if the link aggregation is configured for a layer 2 switch device by bundling a plurality of physical ports, the bandwidth cannot be distributed evenly across the physical ports, so that the total sum of bandwidths of the plurality of physical ports cannot be provided. Therefore, significant bandwidth resources of a carrier network cannot be effectively used. For example, even if 4 physical ports for 100 Mbps Fast Ethernet (Ethernet: registered trademark) are bundled into one to provide a user with a logical port for 400 Mbps, the bandwidth cannot actually be distributed evenly across the plurality of physical ports due to unbalanced traffic, so that the bandwidth of 400 Mbps cannot be secured.

(2) Even if the link aggregation is set for a layer 2 switch device, QoS is assured on a physical port (virtual path) basis, so that significant bandwidth resources of a carrier network are wasted. Therefore, Patent document 1 proposes the method, such as the link aggregation, of performing QoS control on a logical port (virtual path bundle) basis. However, the document does not make a proposal for packet discard to be performed when a contractor breaches the limitation of a maximum usable bandwidth. Therefore, if the traffic exceeds the maximum usable bandwidth for the link aggregation, communication within a QoS bandwidth cannot be assured. Accordingly, the communication carrier cannot provide a highly reliable wide-area LAN service.

The following are related arts to the present invention.
[Patent document 1]
Japanese Patent Laid-Open Publication No. 8-186568
[Patent document 2]
Japanese Patent Laid-Open Publication No. 10-341235

### SUMMARY OF THE INVENTION

The present invention has an object to provide a technology for allowing bandwidth distribution to be performed evenly (strictly speaking, substantially evenly) across a plurality of physical ports composing a logical port for link aggregation.

The present invention has another object to provide a technique for allowing packet discard to be performed when a contractor (user) breaches the limitation of a maximum usable bandwidth in order to accelerate bandwidth distribution to be performed evenly across a plurality of physical ports composing a logical port for link aggregation.

In order to solve the problems, a first traffic distribution control device according to the present invention is a traffic distribution control device which, in order to distribute traffic across a plurality of physical ports composing a logical port for link aggregation, uses a hash function to calculate a hash value from a destination address and a source address of a receive packet, and determines a destination physical port, the traffic distribution control device including:
a measuring unit measuring an output flow rate of a packet outputted from each of the plurality of physical ports;
a calculating unit calculating a flow rate ratio between the plurality of physical ports with respect to the measured output flow rates; and
a first control unit feeding the calculated flow rate ratio back to a bandwidth distribution ratio between the plurality of physical ports to change numerical allocation of hash values for determining the destination physical port.

Here, when feeding the flow rate ratio back to the bandwidth distribution ratio, the first control unit uses a bandwidth distribution ratio feedback coefficient to recalculate the numerical allocation of hash values, thereby feeding part of the f low rate ratio back to the bandwidth distribution ratio.

The first traffic distribution control device further includes a second control unit requesting, when packet discard is performed on the condition that bandwidth assurance is performed using the logical port for the link aggregation as a unit, the packet discard of a physical port having the highest output flow rate with a high priority in order to equalize output flow rates of the plurality of physical ports.

A second traffic distribution control device according to the present invention is a traffic distribution control device which, in order to distribute traffic across a plurality of physical ports composing a logical port for link aggregation, performs packet discard on the condition that bandwidth assurance is performed using the logical port as a unit, the traffic distribution control device including:
a measuring unit measuring output flow rates of packets outputted from each of the plurality of physical ports; and
a control unit calculating an excess amount of a maximum usable bandwidth from a difference between a total sum of the measured output flow rates and a preset maximum usable bandwidth of the logical port, and requests the packet discard of a physical port having the highest output flow rate with a high priority in order to equalize output flow rates of the plurality of physical ports.

A third traffic distribution control device according to the present invention is a traffic distribution control device including:
a measuring unit measuring an output flow rate for each hash value for performing traffic distribution;
a calculating unit calculating a flow rate ratio between flow rates measured corresponding to each hash value; and
a control unit, based on the calculated flow rate ratio, adjusts a combination of hash values allocated to a plurality of physical ports configuring link aggregation to equalize traffic.

According to the present invention, even when bandwidth distribution for link aggregation exhibits an imbalance, a ratio (flow rate ratio) of bandwidths used by a plurality of physical ports is fed back to improve a bandwidth distribution ratio, so that traffic distribution for the link aggregation can be performed evenly. Accordingly, the total sum of the bandwidths of the plurality of physical ports can be provided, and hence significant bandwidth resources of a carrier network can be effectively used.

Further, according to the present invention, even if the total flow rate for the link aggregation exceeds a maximum usable bandwidth, the physical ports configuring the link aggregation can be subjected to packet discard in descending order from the highest flow rate thereof to achieve even output flow rates, and the influence on traffic already in communication can be suppressed to a minimum. Accordingly, a communication carrier can provide a highly reliable wide-area LAN service.

Other objects, features, and advantages of the present invention will become apparent by reference to the specification described below when being referred to along with drawings and accompanying claims.

### BRIEF DESCRIPTION OF THE DRAWINGS

FIG. 1 is a block diagram showing a configuration of a wide-area LAN service system to which a data transmission device according to an embodiment of the present invention is applied.

FIG. 2 is a diagram illustrating a logical port for link aggregation according to a conventional art.

FIG. 3 is a diagram illustrating an example of equalized traffic distribution for the link aggregation according to the conventional art.

FIG. 4 is a diagram illustrating a case where the traffic distribution using hash values is equalized according to the conventional art.

FIG. 5 is a diagram illustrating a case where the traffic distribution using hash values is not equalized according to the conventional art.

FIG. 6 is a diagram illustrating bandwidth assurance using the link aggregation according to the conventional art.

FIG. 7 is a diagram illustrating discard control for virtual paths according to a conventional ATM communication method.

FIG. 8 is a block diagram showing a configuration of the data transmission device according to the embodiment of the present invention.

FIG. 9 is a diagram illustrating equalized traffic distribution using feedback of measured bandwidths.

FIG. 10 is a diagram illustrating equalized traffic discard using the feedback of measured bandwidths.

FIG. 11 is a diagram showing an example of a network configuration in each operational mode.

FIG. 12 is a diagram illustrating a method of determining an output physical port, which is performed by a device 1 in first and second operational modes.

FIG. 13 is a diagram illustrating a method of determining the output physical port after the feedback of measured bandwidths, which is performed by the device 1 in the first and second operational modes.

FIG. 14 is a diagram illustrating a method of determining the output physical port with a bandwidth distribution ratio feedback coefficient taken into consideration, which is performed by the device 1 in the first and second operational modes.

FIG. 15 is a diagram illustrating a method of measuring an amount of packets discarded when exceeding a maximum usable bandwidth, which is performed by the device 1 in third and fourth operational modes.

FIG. 16 is a diagram illustrating a method of measuring the amount of packets discarded when exceeding the maximum usable bandwidth, which is performed by the device 1 in the third and fourth operational modes.

FIG. 17 is a diagram illustrating how packets are discarded from an output physical port of the device 1 in the third and fourth operational modes.

FIG. 18 is a diagram illustrating how packets are discarded from the output physical port of the device 1 in the third and fourth operational modes.

FIG. 19 is a diagram illustrating a MAC address learning table.

FIG. 20 is a diagram illustrating a link aggregation control table.

FIG. 21 is a diagram illustrating a forwarding table.

FIG. 22 is a diagram illustrating bandwidth notification data.

FIG. 23 is a diagram illustrating link aggregation measured bandwidth ratio notification data.

FIG. 24 is a diagram illustrating feedback of measured bandwidths to a distribution algorithm.

FIG. 25 is a diagram illustrating bandwidth distribution ratio feedback coefficient data.

FIG. 26 is a diagram illustrating updating of the distribution algorithm for measured bandwidths with a bandwidth distribution ratio feedback coefficient taken into consideration.

FIG. 27 is a diagram illustrating multicast bandwidth notification data.

FIG. 28 is a diagram illustrating logical port maximum usable bandwidth data.

FIG. 29 is a diagram illustrating unicast corresponding discard instruction notification data.

FIG. 30 is a diagram illustrating multicast corresponding discard instruction notification data.

FIG. 31 is a diagram showing a process flow of a link aggregation management unit in the first and second operational modes.

FIG. 32 is a diagram showing a process flow (⅓) of a bandwidth allocation control unit in the first and second operational modes.

FIG. 33 is a diagram showing a process flow (⅔) of the bandwidth allocation control unit in the first and second operational modes.

FIG. 34 is a diagram showing a process flow ( 3/3) of the bandwidth allocation control unit in the first and second operational modes.

FIG. 35 is a diagram showing a process flow of a bandwidth measuring unit in the first and second operational modes.

FIG. 36 is a diagram showing a process flow of a link aggregation bandwidth control unit in the first and second operational modes.

FIG. 37 is a diagram showing a process flow of the link aggregation management unit in third and fourth operational modes.

FIG. 38 is a diagram showing a process flow (½) of the bandwidth measuring unit in the third and fourth operational modes.

FIG. 39 is a diagram showing a process flow ( 2/2) of the bandwidth measuring unit in the third and fourth operational modes.

FIG. 40 is a diagram showing a process flow (⅓) of the link aggregation bandwidth control unit in the third and fourth operational modes.

FIG. 41 is a diagram showing a process flow (⅔) of the link aggregation bandwidth control unit in the third and fourth operational modes.

FIG. 42 is a diagram showing a process flow ( 3/3) of the link aggregation bandwidth control unit in the third and fourth operational modes.

FIG. 43 is a diagram illustrating a forwarding table in a modified operational mode of the first and second operational modes.

FIG. 44 is a diagram illustrating hash value corresponding bandwidth measurement data in the modified operational mode of the first and second operational modes.

FIG. 45 is a diagram illustrating hash value corresponding bandwidth ratio data in the modified operational mode of the first and second operational modes.

FIG. 46 is a diagram illustrating bandwidth ratio data for each physical port in the modified operational mode of the first and second operational modes.

FIG. 47 is a diagram illustrating hash values allocated to each port in the modified operational mode of the first and second operational modes.

### DETAILED DESCRIPTION OF THE PREFERRED EMBODIMENTS

Hereinafter, referring to the accompanying drawings, the present invention will be described in further detail. The drawings show a preferred embodiment of the present invention. However, the present invention can be implemented in many various embodiments, and should not be construed to be restricted to the embodiment described in the specification. Those embodiments are provided so as rather to make the disclosure of the specification thorough and complete, and to sufficiently teach the scope of the present invention to those skilled in the art.

[Configuration of Data Transmission Device]

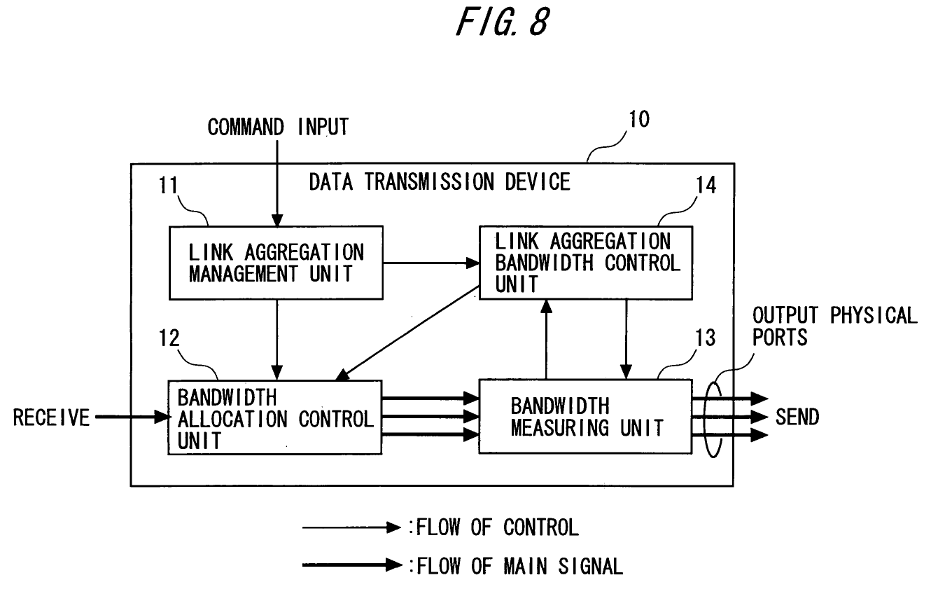

Referring to FIG. 8 showing a configuration of a data transmission device according to an embodiment of the present invention, a data transmission device (layer 2 switch device) 10 serving as a traffic distribution control device includes a link aggregation management unit 11, a bandwidth allocation control unit 12, a bandwidth measuring unit 13, and a link aggregation bandwidth control unit 14. Note that the data transmission device 10 includes a storage unit (not shown) having storage areas that store various tables and various pieces of data.

A first data transmission device 10 is a traffic distribution control device that, in order to distribute traffic across a plurality of physical ports composing a logical port for link aggregation, uses a hash function to calculate a hash value from a destination address and source address of a receive packet and determine a destination physical port. The bandwidth measuring unit 13 measures output flow rates of packets outputted from the plurality of physical ports. The link aggregation bandwidth control unit 14 calculates a flow rate ratio between the plurality of physical ports with respect to the measured output flow rates. The bandwidth allocation control unit 12 feeds the calculated flow rate ratio between the plurality of physical ports back to a bandwidth distribution ratio, and changes numerical allocation of hash values for determining the destination physical port.

Here, when feeding the flow rate ratio back to the bandwidth distribution ratio, the bandwidth allocation control unit 12 uses a bandwidth distribution ratio feedback coefficient to recalculate the numerical allocation of hash values, thereby feeding part of the flow rate ratio back to the bandwidth distribution ratio.

When performing packet discard on the condition that bandwidth assurance is performed in the unit of a logical port for link aggregation, the link aggregation bandwidth control unit 14 requests that the packets for the physical port of the highest output flow rate be discarded with a high priority in order to equalize the output flow rates of the plurality of physical ports.

Further, when discarding a packet that has exceeded the maximum usable bandwidth, the link aggregation bandwidth control unit 14 issues a discard request for broadcast packets with a high priority.

A second data transmission device 10 is a traffic distribution control device that, in order to distribute traffic across a plurality of physical ports composing a logical port for link aggregation, performs packet discard on the condition that bandwidth assurance is performed in the unit of a logical port, and the bandwidth measuring unit 13 measures the output flow rates of packets outputted from the plurality of physical ports. The link aggregation bandwidth control unit 14 calculates an excess amount with respect to the maximum usable bandwidth from the difference between the total sum of the measured output flow rates and a preset maximum usable bandwidth, and requests that the packets for the physical port of the highest output flow rate be discarded with a high priority in order to equalize the output flow rates of the plurality of physical ports.

In a third data transmission device 10, the bandwidth measuring unit 13 measures an output flow rate for each hash value for performing traffic distribution. The link aggregation bandwidth control unit 14 calculates an output flow rate ratio corresponding to the measured hash value. In order to equalize traffic, the bandwidth allocation control unit 12 adjusts, based on the calculated flow rate ratio, a combination of hash values to be allocated to the plurality of physical ports composing the link aggregation.

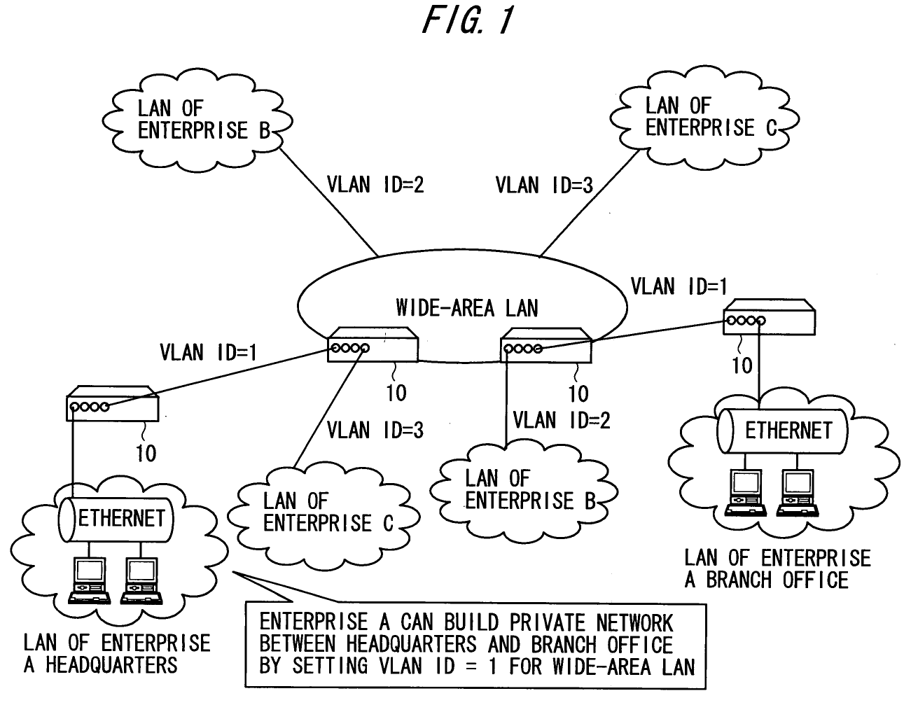

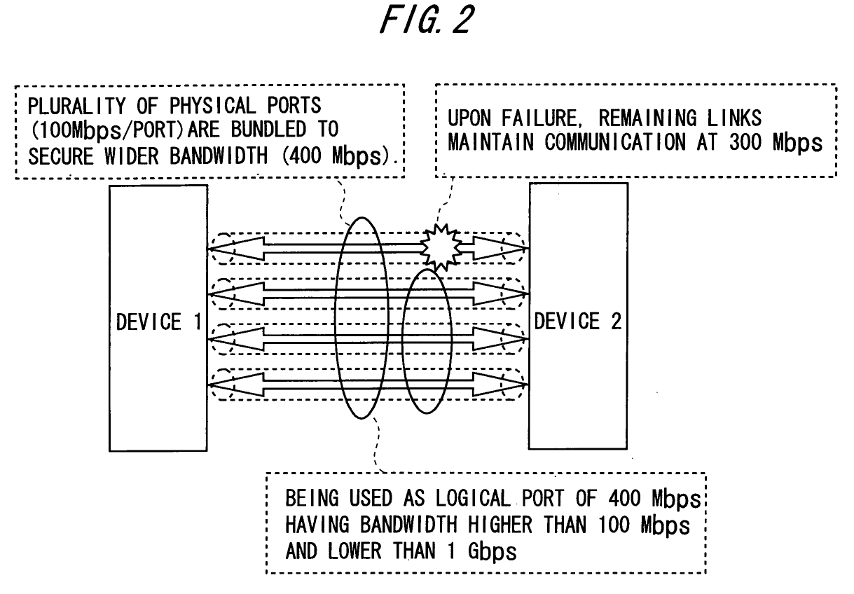

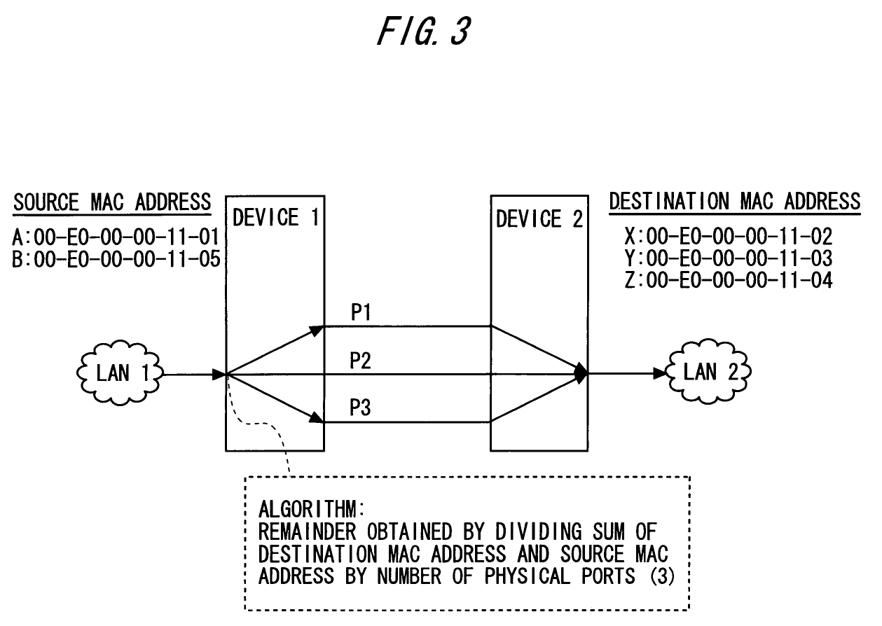

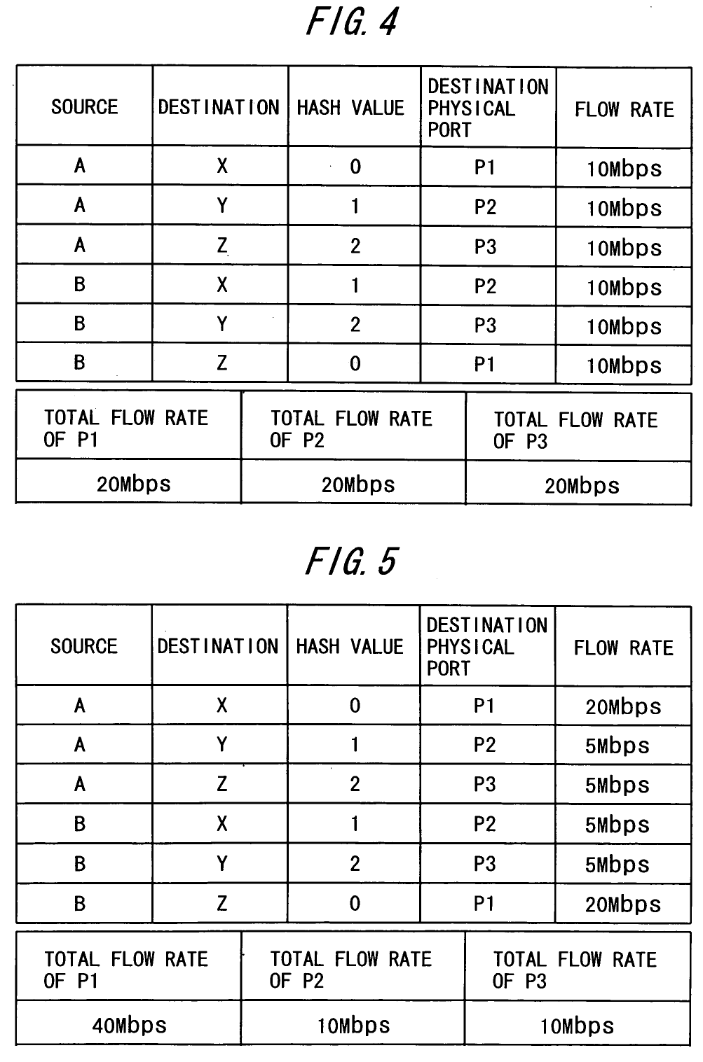

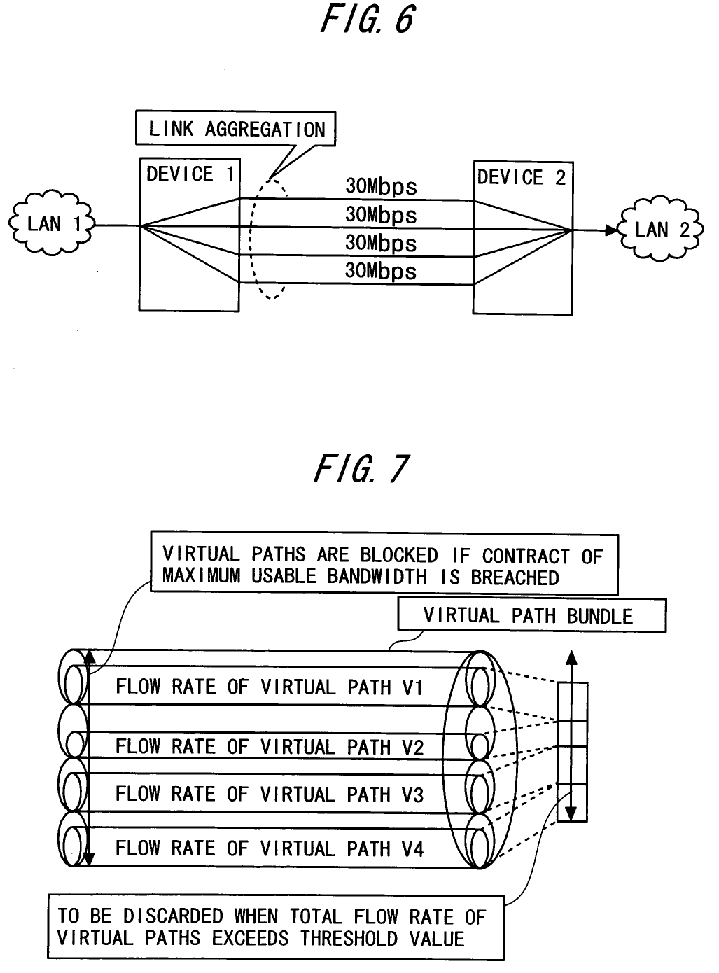

In a wide-area LAN service system shown in FIG. 1, the data transmission devices 10 having such configurations are arranged logically in a an enterprise LAN and a wide-area LAN as layer 2 switch devices 10. In the data transmission device 10 shown in FIG. 8, the bandwidth allocation control unit 12 and the bandwidth measuring unit 13 interface with Ethernet (registered trademark) and an opposing data transmission device 10, respectively.

[Operation of Data Transmission Device]

Next, description will be made of an example of an operation of the data transmission device 10 according to an embodiment of the present invention shown in FIG. 8.

[Outline of First and Second Operational Modes]

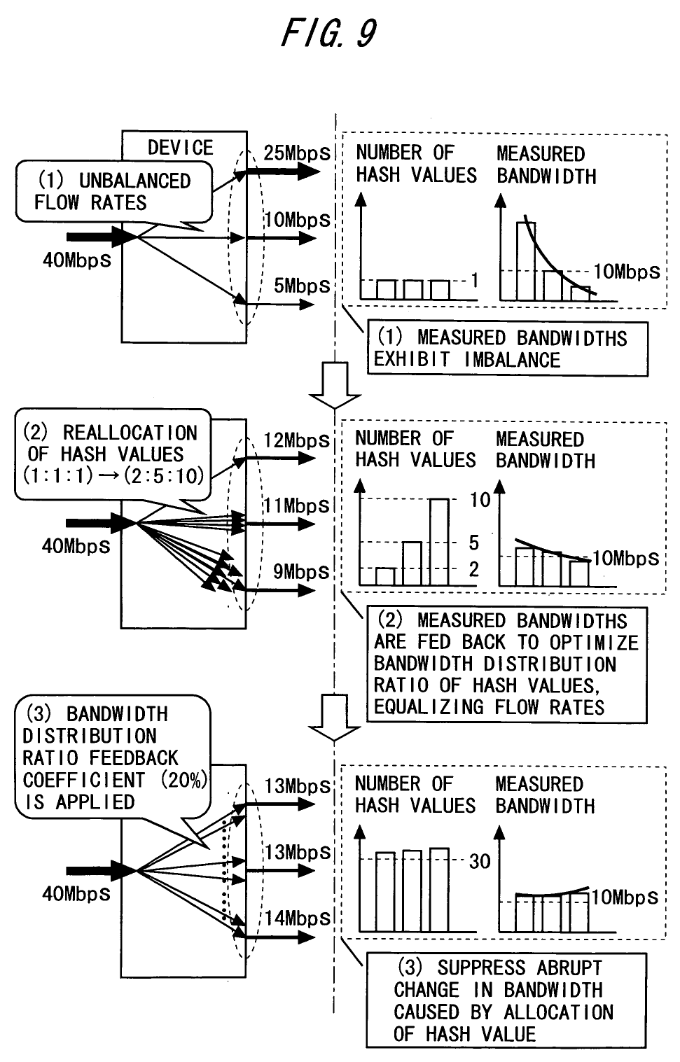

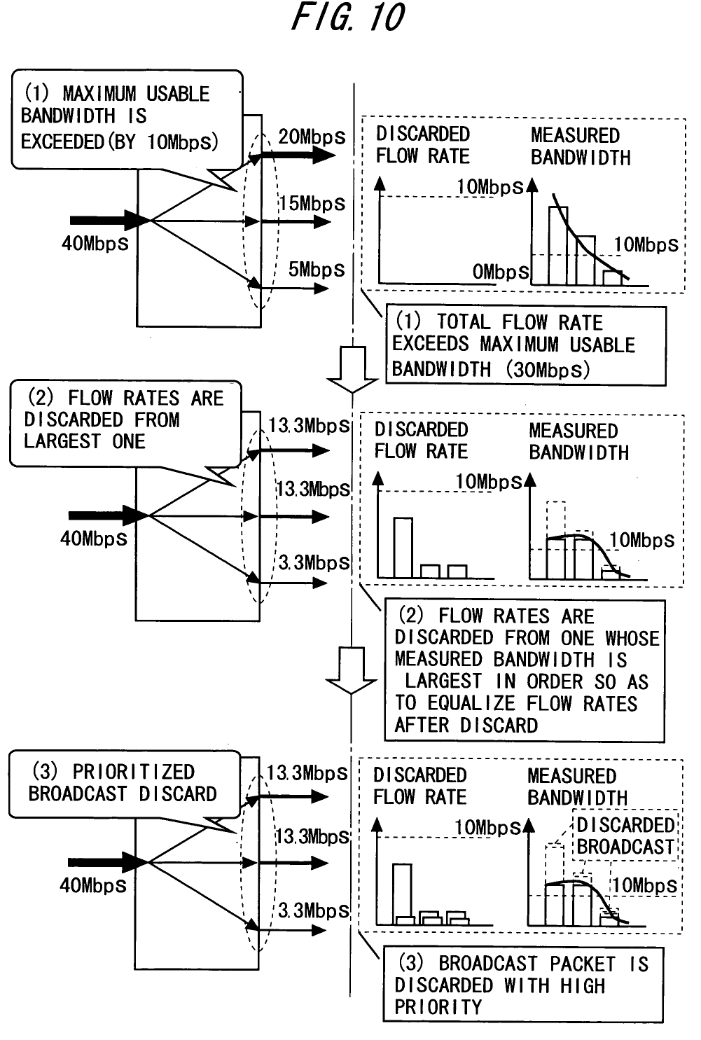

Referring to FIGS. 8 and 9, the data transmission device 10 in a first or second operational mode feeds back an output bandwidth (output flow rate) for the link aggregation to equalize the bandwidth distribution ratio.

Based on the hash value calculated by using a destination address (hereinafter, sometimes referred to simply as “DA”) and source address (hereinafter, sometimes referred to simply as “SA”) of a receive packet, the data transmission device 10 determines an output physical port not fixedly but by adding the flow rate ratio between a plurality of output physical ports composing a logical port, thereby maintaining the equalized flow rate ratio between the output physical ports.

The data transmission device 10 also uses a feedback coefficient for the bandwidth distribution ratio to suppress a drastic fluctuation of the bandwidth distribution ratio.

First, in the data transmission device 10, the bandwidth distribution ratio feedback coefficient requested in advance is received by the link aggregation management unit 11 in response to a command inputted by a device administrator. Then, the link aggregation management unit 11 notifies the bandwidth allocation control unit 12 of the bandwidth distribution ratio feedback coefficient, which is recorded in the bandwidth allocation control unit 12. The term “bandwidth distribution ratio feedback coefficient” as used herein refers to the rate at which an inverse ratio of the measured bandwidth is fed back to hash calculation. For example, if the bandwidth distribution ratio feedback coefficient is 1, feedback is performed at 100%.

In the data transmission device 10, the bandwidth allocation control unit 12 records a DA in a MAC address learning table of the device in order to establish interactive packet communication between a receiving side physical port ((input) physical port for an input) and a sending side logical port for the link aggregation. Thus, if the physical port (input physical port) receives a packet, the bandwidth allocation control unit 12 searches the MAC address learning table based on the DA read from a header of the packet to determine a logical port for the link aggregation.

Then, the bandwidth allocation control unit 12 calculates a hash value based on each SA, DA, and number of physical ports composing the logical port (aggregate port number). Based on the hash value and the logical port, the bandwidth allocation control unit 12 determines an output physical port from a forwarding table to which a receive packet is forwarded.

After the receive packet reaches the output physical port, the bandwidth measuring unit 13 measures the flow rate of the packet and the bandwidth of traffic to be outputted to the output physical port while the packet is registered in one of the send queues provided corresponding to output physical ports. The bandwidth measuring unit 13 further detects a change in measured bandwidth (flow rate) and notifies the link aggregation bandwidth control unit 14 of the measured bandwidth, followed by registration of the received packet in a send queue. The receive packets registered in the send queue are outputted to the outside of the device in the order of being lined up (inputted) in the queue. That is, the receive packets are outputted to a link connected to the opposing data transmission device.

The link aggregation bandwidth control unit 14 that has been notified of the measured bandwidth from the bandwidth measuring unit 13 reads respective measured bandwidths of physical ports composing the logical port, that is, physical ports serving as the structural components of the logical port for the link aggregation, and calculates an integer ratio between the measured bandwidths. The link aggregation bandwidth control unit 14 notifies the bandwidth allocation control unit 12 of the integer ratio.

The bandwidth allocation control unit 12 that has been notified of the measured bandwidth ratio calculates an integer ratio of the inverse ratio of the measured bandwidth ratio and the total sum of integer ratio values, and based on the results, performs a change in hash value allocation.

Normally, once the link aggregation is configured, such optimization of bandwidth distribution by the change in hash value allocation is not performed. However, in the data transmission device 10, as shown in a change from state (1) to state (2) of FIG. 9, the calculation is performed such that the number of hash values of the physical port exhibiting the highest packet flow rate is reduced by the largest number, and the number of hash values of the physical port exhibiting a low packet flow rate is increased (first operational mode).

If there exists a large imbalance in the measured bandwidth ratio of which the bandwidth allocation control unit 12 has been notified by the link aggregation bandwidth control unit 14, the hash value allocation recalculated by the bandwidth allocation control unit 12 also exhibits a large imbalance. Depending on the combination of the DA and SA of a receive packet having reached the bandwidth allocation control unit 12, many receive packets are forwarded to a physical port allocated with many hash values, the traffic may abruptly concentrate on the physical port. In order to avoid this, if the bandwidth distribution ratio feedback coefficient is recorded, the bandwidth allocation control unit 12 uses the bandwidth distribution ratio feedback coefficient to recalculate the hash value allocation. As shown in state (3) of FIG. 9, the allocated numbers of hash values are regulated to have a margin smaller than in state (2) of FIG. 9 (second operational mode).

The bandwidth allocation control unit 12 accesses a link aggregation control table and the forwarding table to write calculation results therein. Receive packets that reach the bandwidth allocation control unit 12 thereafter are distributed across the physical ports composing the link aggregation at a new bandwidth distribution ratio.

Accordingly, in the data transmission device 10 adopting the first and second operational modes, it is possible to distribute unbalanced bandwidths evenly.

[Outline of Third and Fourth Operational Modes]

Referring to FIGS. 8 and 10, the data transmission device 10 in third and fourth operational modes feeds back an output bandwidth (output flow rate) for the link aggregation to equalize the packet discard within a QoS bandwidth.

In the case where the total flow rate exceeds the maximum usable bandwidth, instead of performing the packet discard evenly in the unit of a logical port, the data transmission device 10 performs the packet discard in the order from the output physical port having a high output flow rate composing the logical port, thereby maintaining traffic being distributed evenly across the output physical port.

Further, the data transmission device 10 discards broadcast packets including one whose DA has not been learned with a high priority for one-way communication to suppress the influence on the traffic during communication to a minimum.

First, in the data transmission device 10, the link aggregation management unit 11 receives a maximum usable bandwidth of the logical port requested in advance in response to a command inputted by a device administrator, and the link aggregation bandwidth control unit 14 records the maximum usable bandwidth of the logical port.

Upon receiving packets having reached the data transmission device 10, the bandwidth allocation control unit 12 allocates the receive packets to the physical ports composing the link aggregation, and notifies the bandwidth measuring unit 13. The process performed by the bandwidth allocation control unit 12 so far is the same as that in the first and second operational modes and its detailed description will thus be omitted.

When the receive packets are sent from the bandwidth allocation control unit 12 and reaches the bandwidth measuring unit 13, the bandwidth measuring unit 13 measures the bandwidths used by the received packets, detects a change in measured bandwidths, and notifies the link aggregation bandwidth control unit 14 to notify the measured bandwidths.

The link aggregation bandwidth control unit 14 notified of the measured bandwidths reads the measured bandwidths of the physical ports composing the logical port to calculate the total measured bandwidth. The link aggregation bandwidth control unit 14 calculates the excess amount with respect to the maximum usable bandwidth from the difference between the maximum usable bandwidth of the logical port and the measured bandwidth.

Normally, a discard bandwidth is set by a device administrator in the unit of a physical port composing the link aggregation, and is not automatically reset. In such an operational mode, if the maximum usable bandwidth is exceeded, the discard bandwidth of each structural physical port is calculated such that the physical port having the highest traffic flow rate has the highest flow rate discarded.

Accordingly, as shown in a change from state (1) to state (2) of FIG. 10, the link aggregation bandwidth control unit 14 distributes the discard bandwidths to the structural physical ports such that a discarded flow rate is increased for the physical port having a large measured bandwidth and is reduced for the physical port having a small measured bandwidth (third operational mode).

Further, when the notified measured bandwidths include a bandwidth for transmission of broadcast packets, the data transmission device 10 puts a high priority on discard of broadcast packets for the calculation.

Normally, regardless of a broadcast packet or unicast packet, the discard takes place evenly. However, in the operational mode, when the discard bandwidth is calculated from the measured bandwidth notified of by the bandwidth measuring unit 13, the link aggregation bandwidth control unit 14 calculates the discard bandwidth for unicast packets and the discard bandwidth of broadcast packets such that the broadcast packets are discarded with a high priority.

Accordingly, as shown in state (3) of FIG. 10, the data transmission device 10 adopts a process of discarding a broadcast packet with a high priority (fourth operational mode).

In the data transmission device 10 adopting the third and fourth operational modes, the link aggregation bandwidth control unit 14 that has completed the calculation of the discard bandwidths notifies the bandwidth measuring unit 13 of the calculation results. The bandwidth measuring unit 13 notified of the discard bandwidths sets the discard bandwidths for the send queues.

When the receive packets are sent thereafter from the bandwidth allocation control unit 12 and reach the bandwidth measuring unit 13, the bandwidth measuring unit 13 reads the DA of each receive packet and determines whether the receive packet is registered in a unicast send queue or a multicast send queue.

If the DA is a broadcast address, the bandwidth measuring unit 13 registers the receive packet in the multicast send queue. The receive packet registered in each send queue is normally outputted to the outside of the device. However, if the outputted packet flow rate exceeds the discard bandwidth set for each send queue, the receive packet is discarded.

Accordingly, in the data transmission device 10 adopting the third and fourth operational modes, it is possible to distribute the traffic evenly within a QoS bandwidth and suppress the influence on the traffic during communication to a minimum.

[Specific Example of First and Second Operational Modes]

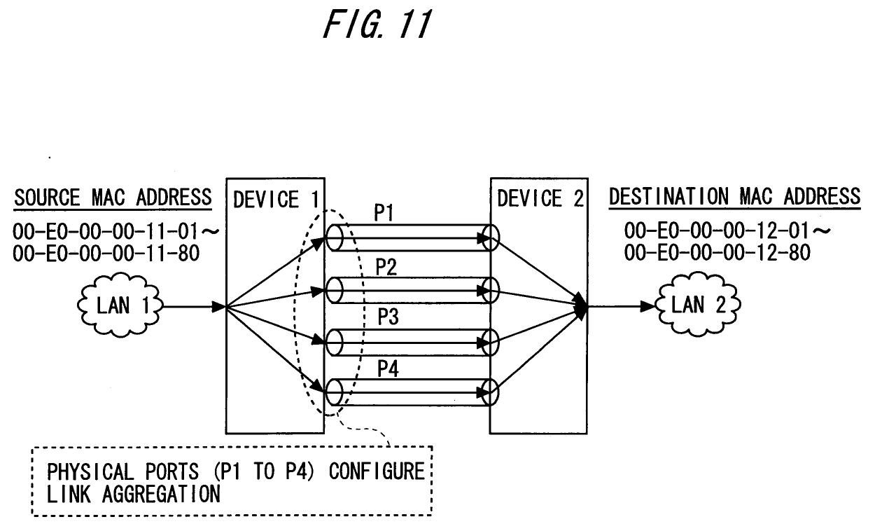

FIG. 11 shows a configuration example of a network (wide-area LAN service system) in which the data transmission device 10 shown in FIG. 8 is applied as a traffic distribution control device (device 1).

In the network configuration, it is assumed that the enterprise network LAN 1 and the enterprise network LAN 2 are each connected with the device 1 and the device 2 (data transmission device), respectively, through Fast Ethernet (Ethernet: registered trademark) ports having no link aggregation configuration (100 Mbps), and the devices 1 and 2 have the link aggregation configured therebetween through 4 Fast Ethernet (Ethernet: registered trademark) ports (100 Mbps) and are connected with each other through a link aggregation logical port of 400 Mbps.

Here, it is assumed that source MAC addresses SAs: 00-E0-00-00-11-01 to 00-E0-00-00-11-80 exist in the network LAN 1, destination MAC addresses DAs: 00-E0-00-00-12-01 to 00-E0-00-00-12-80 exist in the network LAN 2, the network LAN 1 and the network LAN 2 are already in interactive communication, and forwarding destination MAC addresses are already learned in forwarding tables of the devices 1 and 2.

(First Operational Mode)

With regard to the first operational mode, description will be made of a mechanism in which when packets forwarded from the network LAN 1 to the device 1 are sent to the network LAN 2 connected to the device 2 via the link aggregation logical port, the traffic is distributed all across the plurality of physical ports composing the link aggregation.

First, description will be made of an operation performed until a packet, which has reached the device 1 shown in FIG. 11 (data transmission device 10 shown in FIG. 8) from the network LAN 1 through the Ethernet (registered trademark) and has the source MAC address SA: 00-E0-00-00-11-01 and the destination MAC address DA: 00-E0-00-00-12-05, is sent to any one of physical ports composing the link aggregation logical port.

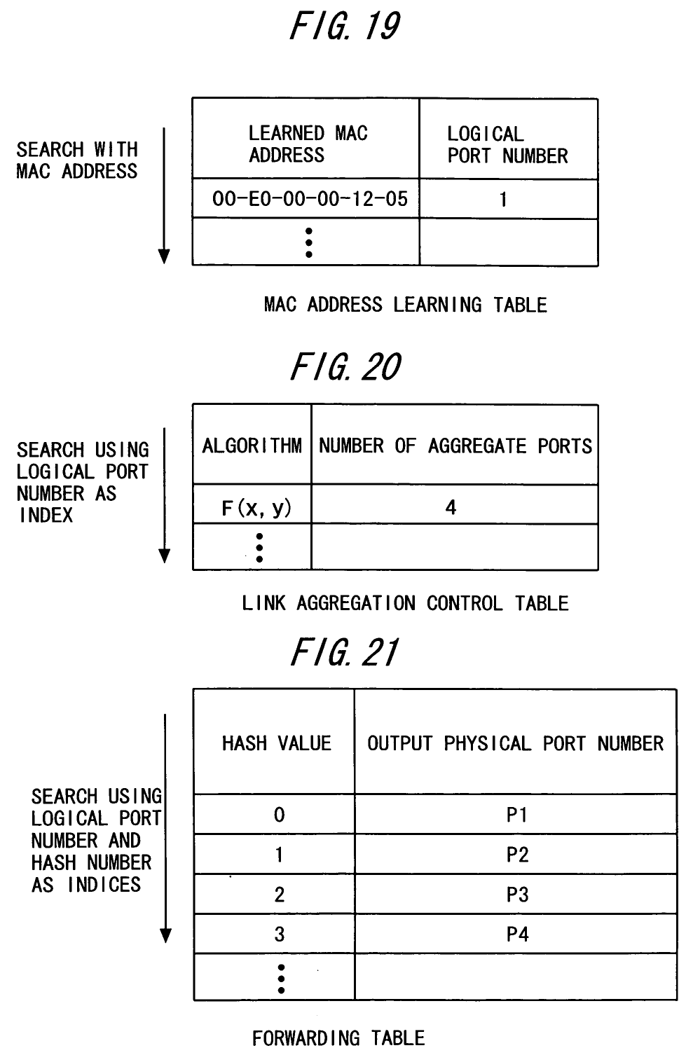

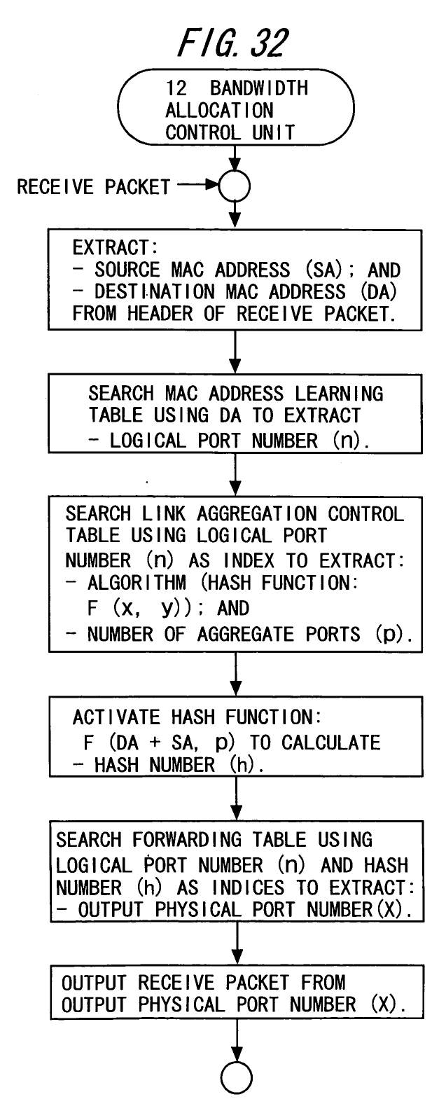

As shown in a process flow of FIG. 32, when the device 1 receives a packet having learned MAC addresses, the bandwidth allocation control unit 12 extracts the source MAC address SA: 00-E0-00-00-11-01 and the destination MAC address DA: 00-E0-00-00-12-05 from the packet header. Further, the bandwidth allocation control unit 12 extracts a logical port number “1” corresponding to the DA (learned MAC address) from the MAC address learning table shown in FIG. 19.

Then, the bandwidth allocation control unit 12 obtains the number of aggregate ports “4” used for the logical port number “1” and a distribution algorithm F(DA+SA, n)=Mod(DA+SA, 4) from the link aggregation control table shown in FIG. 20. The bandwidth allocation control unit 12 calculates the hash value based on those extracted pieces of information. The Mod is a hash function of outputting the remainder obtained by dividing the sum of a DA and a SA by the number of aggregate ports. Here, since DA=00-E0-00-00-12-05, SA=00-E0-00-00-11-01, and the number of aggregate ports=4, the hash value to be outputted is “2”.

The bandwidth allocation control unit 12 subsequently determines an output physical port number “P3” based on the logical port number “1” and the hash value “2” from the forwarding table shown in FIG. 21, and forwards the packet to the bandwidth measuring unit 13.

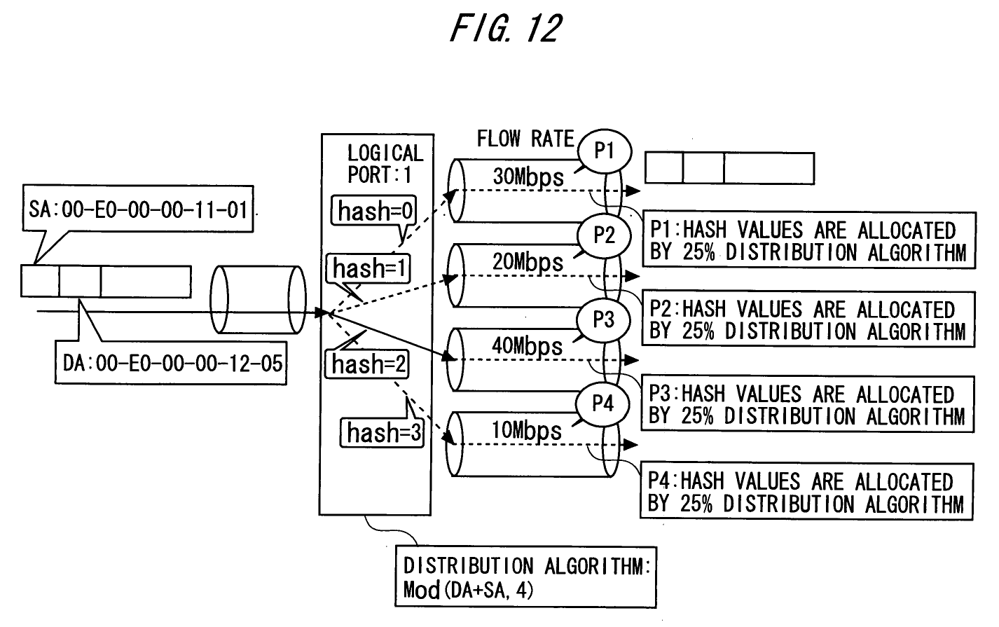

After receiving the receive packet allocated by the bandwidth allocation control unit 12, the bandwidth measuring unit 13 inputs the receive packet in a send queue, and then outputs the receive packet to the output physical port number “P3” in order. At that time, the bandwidth measuring unit 13 measures the output bandwidth of the packet (see FIG. 12).

The description herein is made of the operation in which the packet having the source MAC address SA: 00-E0-00-00-11-01 and the destination MAC address DA: 00-E0-00-00-12-05 that have reached the device 1 is outputted to the physical port P3 serving as one of the physical ports composing the link aggregation logical port. The same operation is used to output a packet having another source MAC address and another destination MAC address to any one of the physical ports composing the link aggregation logical port, and measure the output bandwidth of the packet, but the description of the same operation will be omitted.

Next, description will be made of an operation performed until the bandwidth measuring unit 13 notifies the link aggregation bandwidth control unit 14 of the measured bandwidth of the outputted packet, and the flow rate ratio of the structural physical port is fed back.

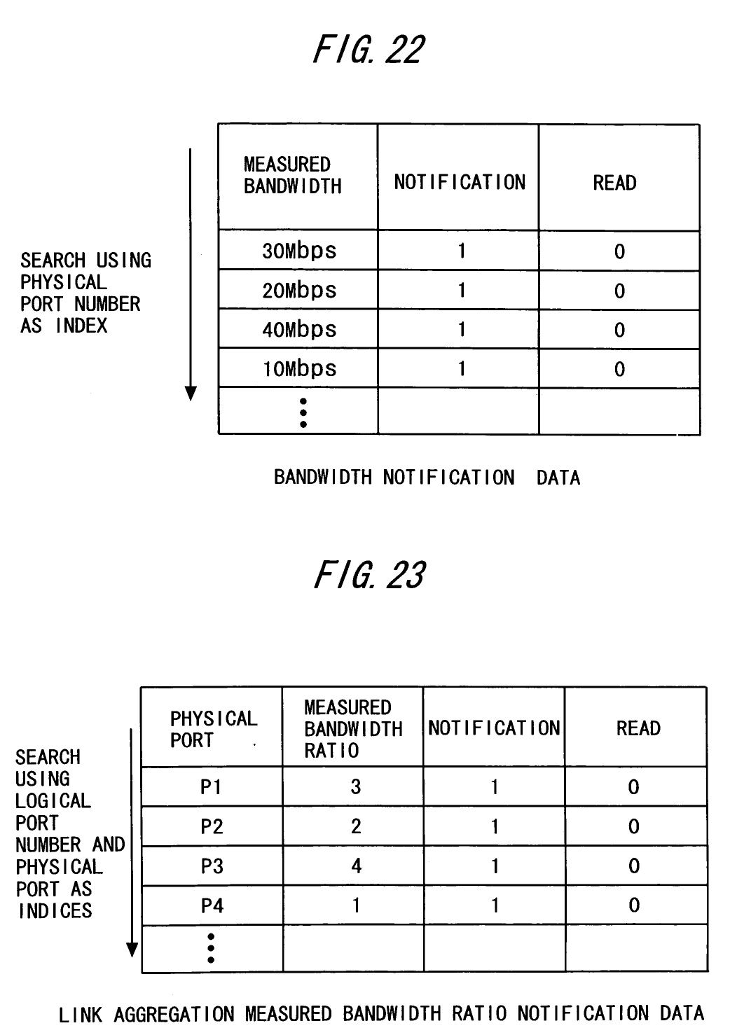

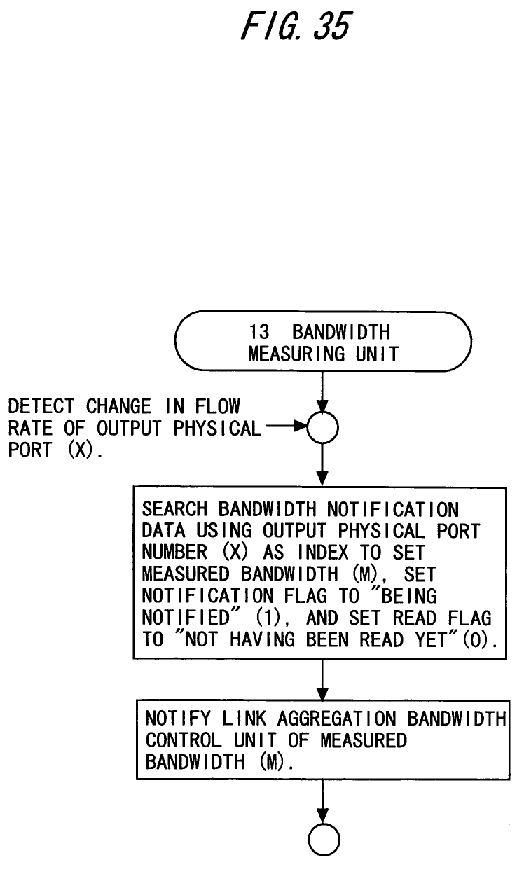

As shown in a process flow of FIG. 35, if there is a change in the flow rate of the output physical port P3, the bandwidth measuring unit 13 notifies the link aggregation bandwidth control unit 14 of bandwidth notification data in which values are written as shown in FIG. 22 such that the measured bandwidth is 40 Mbps, a notification flag indicates “being notified” (1), and a read flag indicates “not having been read yet” (0).

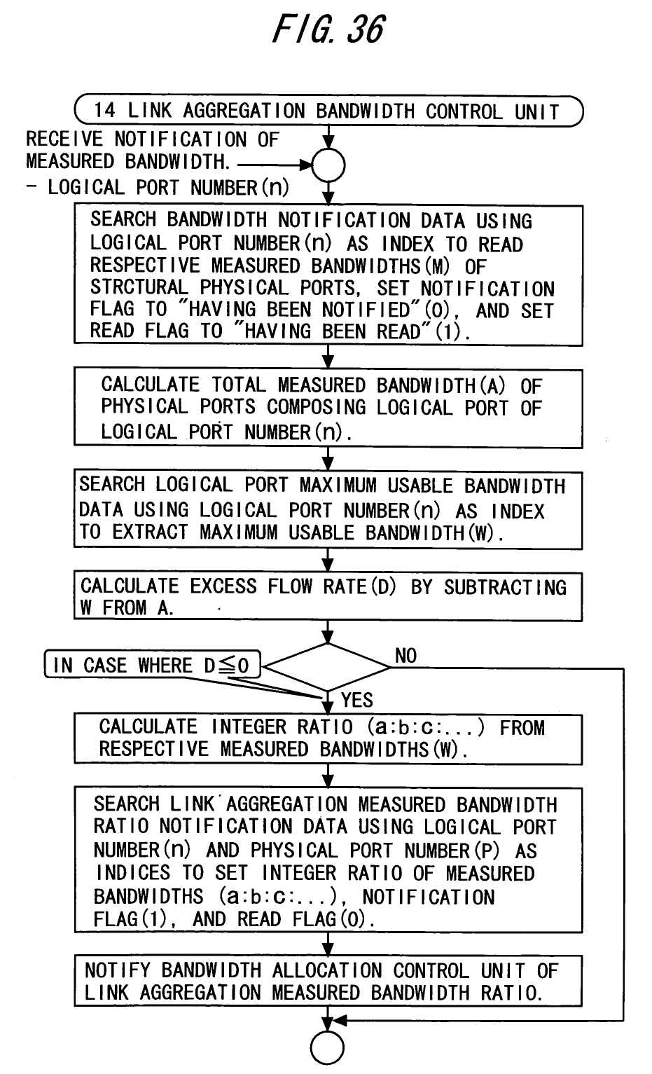

As shown in a process flow of FIG. 36, the link aggregation bandwidth control unit 14 notified of the measured bandwidth reads the measured bandwidth (40 Mbps) from the bandwidth notification data, and sets the notification flag to “having been notified” (0) and the read flag to “having been read” (1). With regard to the output physical ports P1, P2, and P4, the link aggregation bandwidth control unit 14 similarly obtains the measured bandwidth (30 Mbps) for P1, the measured bandwidth (20 Mbps) for P2, and the measured bandwidth (10 Mbps) for P4.

Then, the link aggregation bandwidth control unit 14 calculates the integer ratio among the measured bandwidth of the structural physical ports P1:P2:P3:P4 as 3:2:4:1. From the results, as shown in FIG. 23, the bandwidth control unit 14 writes data in an area of link aggregation measured bandwidth ratio notification data (storage area) corresponding to the physical port P3 such that the measured bandwidth ratio value is (4), the notification flag indicates “being notified” (1), and the read flag indicates “not having been read yet” (0). Further, the bandwidth control unit 14 writes data similarly for the physical ports P1, P2, and P4, and notifies the bandwidth allocation control unit 12 of the link aggregation measured bandwidth ratio notification data.

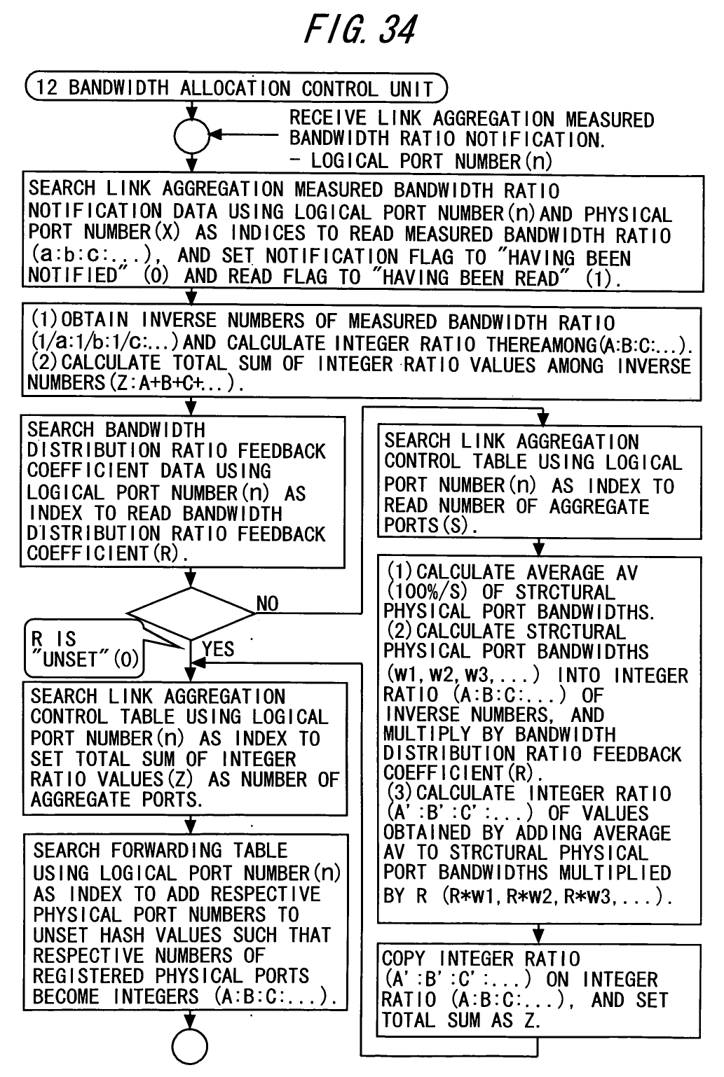

As shown in a process flow of FIG. 34, the bandwidth allocation control unit 12 notified of the measured bandwidth ratio by the link aggregation bandwidth control unit 14 reads the measured bandwidth ratio (4) from the link aggregation measured bandwidth ratio notification data, and writes “having been notified” (0) for the notification flag and “having been read” (1) for the read flag. The bandwidth allocation control unit 12 reads data similarly for the physical ports P1, P2, and P4. Note that the bandwidth distribution ratio feedback coefficient (R) is used in the process flow of FIG. 34, but the process is performed herein on the assumption that the bandwidth distribution ratio feedback coefficient is not set. Description will be made later of an operation using the bandwidth distribution ratio feedback coefficient.

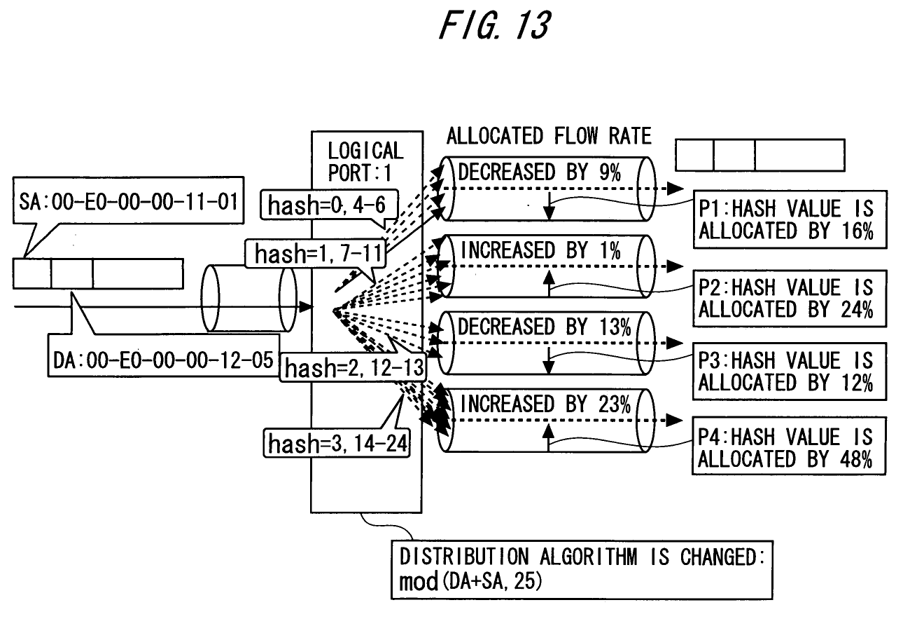

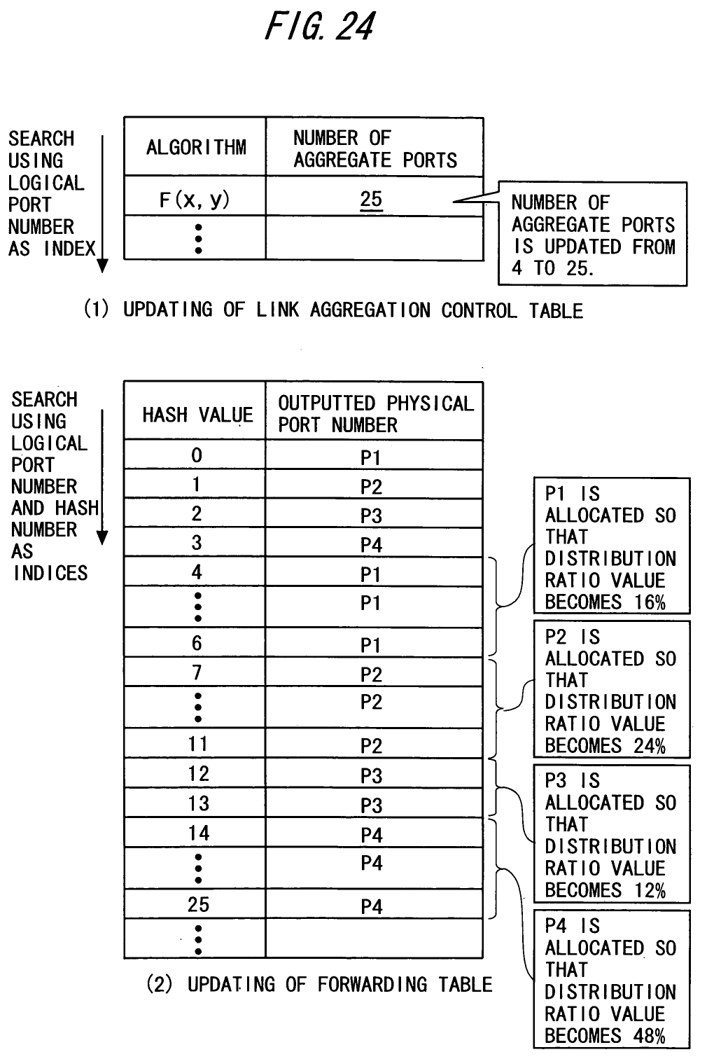

Based on the measured bandwidth ratio among the physical ports P1, P2, P3, and P4 read from the link aggregation measured bandwidth ratio notification data (storage area), which is P1:P2:P3:P4=3:2:4:1, the bandwidth allocation control unit 12 calculates the inverse ratio, that is, 1/P1:1/P2:1/P3:1/P4, as ⅓:½:¼: 1/1=4:6:3:12, and sets the number of aggregate ports as 25 and the hash values as P1 (0, 4 to 6), P2 (1, 7 to 11), P3 (2, 12 to 13), and P4 (3, 14 to 24). Thus, as shown in FIG. 24, the number of aggregate ports in the link aggregation control table (FIG. 20) and the output physical port number in the forwarding table (FIG. 21) are updated. After the update of forwarding table, the bandwidth distribution ratio among the physical ports is expressed as P1 (16%), P2 (24%), P3 (12%), and P4 (48%) (see FIG. 13).

As has been described above, by adopting the first operational mode, the data transmission device 10 can distribute the traffic evenly all across the plurality of physical ports composing the link aggregation.

(Second Operational Mode)

Next, description will be made of an operation in which the bandwidth allocation control unit 12 uses the bandwidth distribution ratio feedback coefficient (20%) to feed back the flow rate ratio. The term “bandwidth distribution ratio feedback” refers to the feedback of the measured bandwidth ratio with the bandwidth distribution ratio feedback coefficient (20%) reflected thereon performed to the bandwidth distribution ratio among the physical ports currently in use.

First, description will be made of an operation for setting a bandwidth distribution ratio feedback coefficient in response to a command from the device administrator.

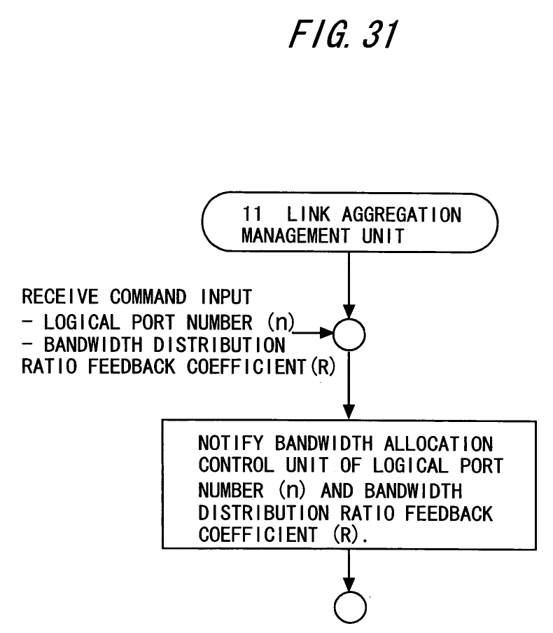

As shown in a process flow of FIG. 31, the link aggregation management unit 11 notifies the bandwidth allocation control unit 12 of the bandwidth distribution ratio feedback coefficient (20%) for the logical port number “1” inputted by a command from the device administrator.

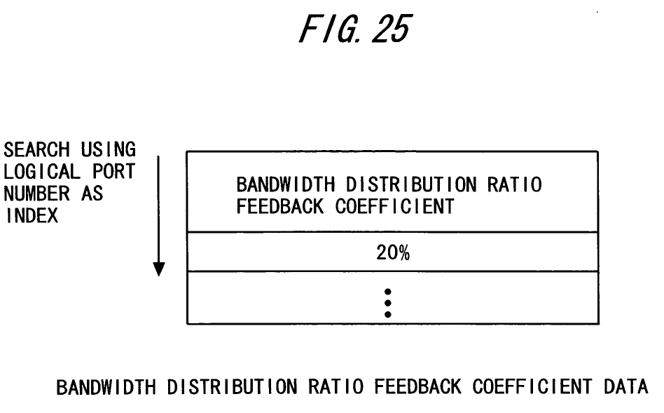

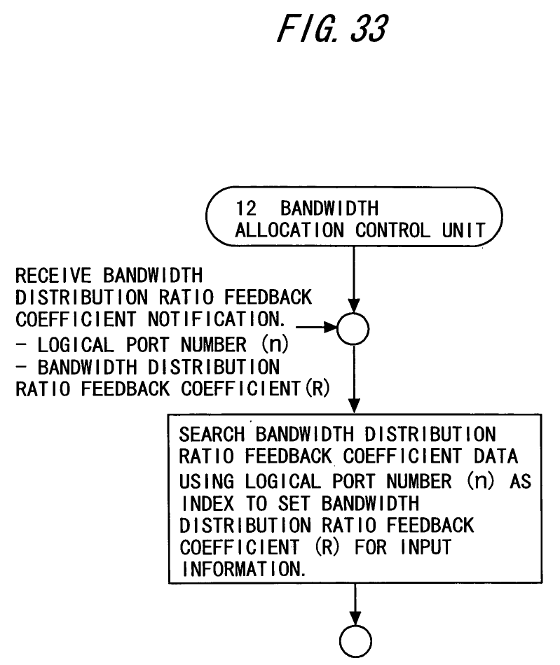

As shown in a process flow of FIG. 33, the bandwidth allocation control unit 12 holds (stores) the bandwidth distribution ratio feedback coefficient (20%) in bandwidth distribution ratio feedback coefficient data (storage area) shown in FIG. 25.

An operation for feeding back a flow rate ratio using a bandwidth distribution ratio feedback coefficient described hereinbelow is performed by the bandwidth allocation control unit 12, while the operations performed by the bandwidth measuring unit 13 and the link aggregation bandwidth control unit 14 are the same as those described in the first operational mode, and their description will be omitted.

As shown in the process flow of FIG. 34, the bandwidth allocation control unit 12 searches the bandwidth distribution ratio feedback coefficient data using the logical port number “1” as an index to read the bandwidth distribution ratio feedback coefficient (20%). Since the bandwidth distribution ratio feedback coefficient is not “unset” (0), the procedure advances to a process of reflecting the bandwidth distribution ratio feedback coefficient (20%) on an integer ratio among the inverse numbers of the measured bandwidths, which is P1:P2:P3:P4=4:6:3:12.

For the simplicity of description, it is assumed that the bandwidth distribution ratio among 4 structural physical ports composing the link aggregation logical port, which has not undergone the bandwidth distribution ratio feedback, is expressed by P1 (25%), P2 (25%), P3 (25%), and P4 (25%).

First, based on the integer ratio among the inverse numbers of the measured bandwidths, which is P1:P2:P3:P4=4:6:3:12, the bandwidth allocation control unit 12 obtains a bandwidth distribution ratio X(P1) of P1 by an integer ratio of P1×100/a total sum of integer ratio values, which is 4×100/25=16. Further, the bandwidth allocation control unit 12 calculates a feedback ratio value of P1 X′ (P1) by multiplying by bandwidth distribution ratio feedback coefficient (20%), which is (16×0.2)=3.2.

The bandwidth allocation control unit 12 adds the results to the current bandwidth distribution ratio value (25%) of P1 to calculate Y(P1) as 3.2+25=28.2. Further, the similar calculation is performed on P2, P3, and P4 for obtaining the ratio Y(P1:P2:P3:P4) as 28.2:29.8:27.4:34.6.

In addition, a distribution ratio value Y′ (P1) with the total sum of distribution ratio values being 100 is calculated as Y(P1)×100/a total sum Y(Px)=28.2×100/120=23.5. The similar calculation is performed on P2, P3, and P4 for obtaining the ratio Y′ (P1:P2:P3:P4) as 23.5:24.8:22.8:28.8, and the integer ratio with the total sum of distribution ratio values being 100 is calculated as 23:25:23:29. The total sum of distribution ratio values of 100 described herein corresponds to the number of aggregate ports that is set in the link aggregation control table described later.

The description is made herein with the total sum of distribution ratio values being 100, but the operation can be performed with the total sum of distribution ratio values being any value. As the total sum of distribution ratio values is set to the larger value, the bandwidth distribution can be controlled more precisely.

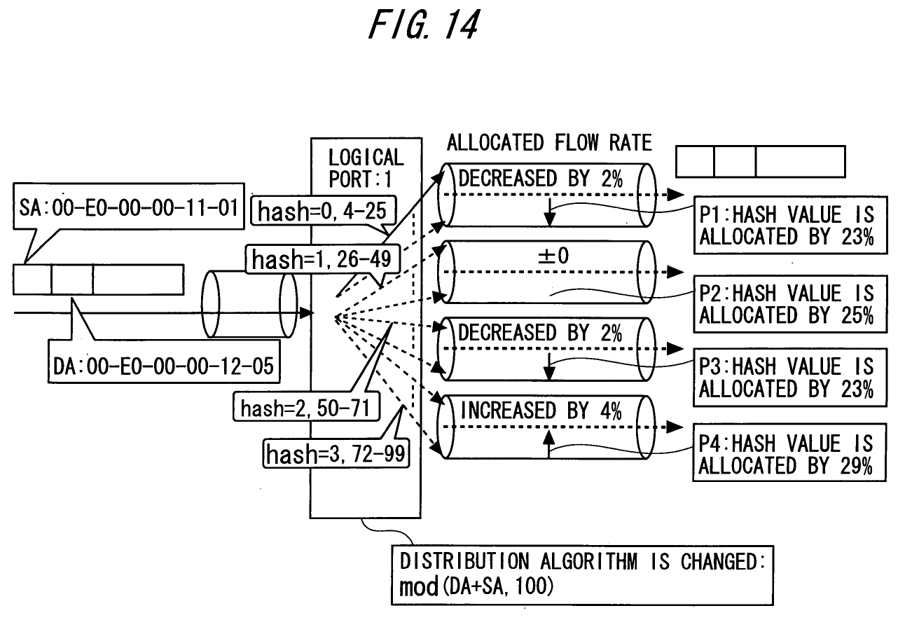

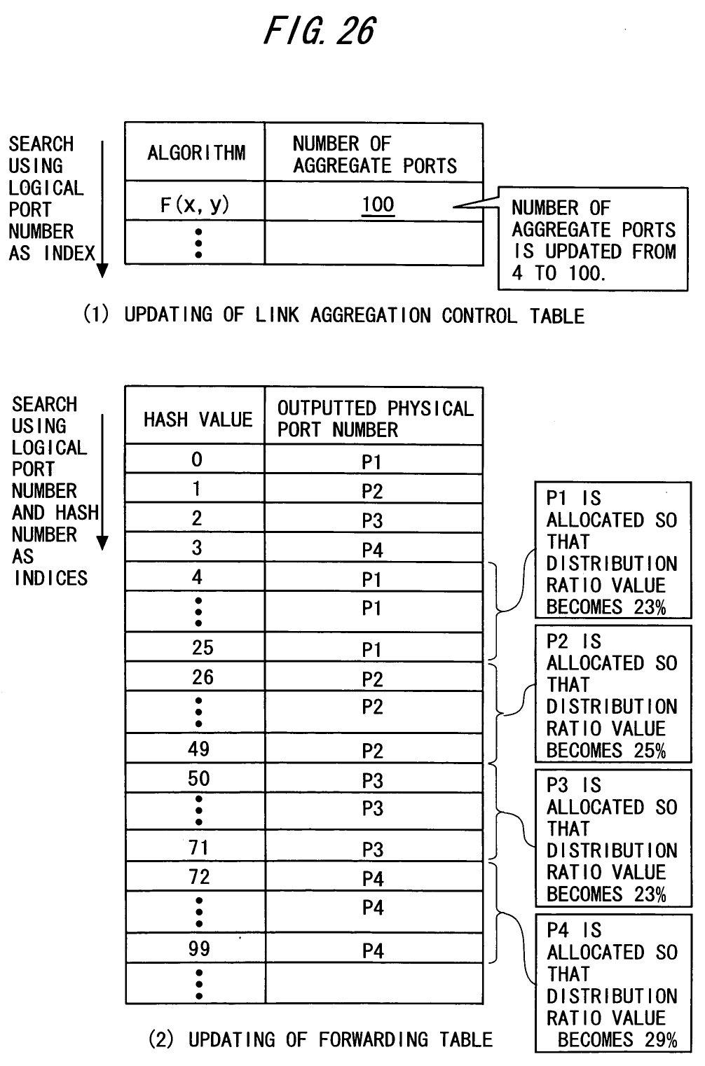

Next, as shown in FIG. 26, the bandwidth allocation control unit 12 searches the link aggregation control table using the logical port number “1” as an index to update the number of aggregate ports into a value with the total sum of distribution ratio values being 100. Also, the bandwidth allocation control unit 12 searches the forwarding table using the logical port number “1” and the hash values as indices to update data such that allocation to the physical ports is performed as P1 (0, 4 to 25), P2 (1, 26 to 49), P3 (2, 50 to 71), and P4 (3, 72 to 99). After the update, the bandwidth distribution ratio among the physical ports is expressed by P1 (23%), P2 (25%), P3 (23%) and P4 (29%) (see FIG. 14).

As has been described above, in the data transmission device 10 adopting the second operational mode, part of the bandwidth ratio undergoes the feedback, making it possible to suppress extreme traffic replacement.

[Specific Example of Third and Fourth Operational Modes]

FIG. 11 shows the configuration example of the network (wide-area LAN service system) in which the data transmission device 10 shown in FIG. 8 is applied as the traffic distribution control device (device 1).

In the network configuration, it is assumed that the enterprise network LAN 1 and the enterprise network LAN 2 are each connected with the device 1 and the device 2 (data transmission device), respectively, through the Fast Ethernet (Ethernet: registered trademark) ports having no link aggregation configuration (100 Mbps), and the devices 1 and 2 have the link aggregation configured therebetween through the 4 Fast Ethernet (Ethernet: registered trademark) ports (100 Mbps) and are connected with each other through the link aggregation logical port of 400 Mbps.

Here, it is assumed that the source MAC addresses SAs: 00-E0-00-00-11-01 to 00-E0-00-00-11-80 exist in the network LAN 1, the destination MAC addresses DAs: 00-E0-00-00-12-01 to 00-E0-00-00-12-80 exist in the network LAN 2, the network LAN 1 and the network LAN 2 are already in interactive communication, and the forwarding destination MAC addresses are already learned in the forwarding tables of the devices 1 and 2.

(Third Operational Mode)

With regard to the third operational mode, description will be made of a packet discard operation in the case where the user flows the traffic at a flow rate exceeding 100 Mbps while the maximum usable bandwidth of the link aggregation logical port for connecting the devices 1 and 2 is set to 100 Mbps.

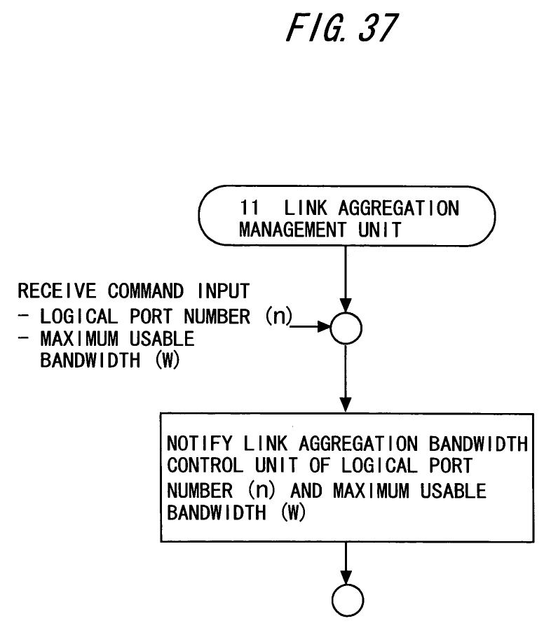

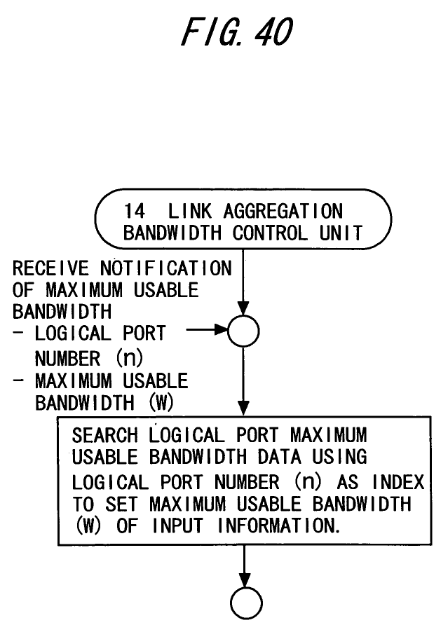

First, description will be made of a process of setting a maximum usable bandwidth in response to a command from the device administrator. As shown in process flows of FIGS. 37 and 40, the link aggregation management unit 11 notifies the link aggregation bandwidth control unit 14 of the maximum usable bandwidth (100 Mbps) of the logical port number “1” inputted by a command from the device administrator, and the link aggregation bandwidth control unit 14 holds (stores) the maximum usable bandwidth (100 Mbps) in logical port maximum usable bandwidth data (storage area) shown in FIG. 28.

Next, description will be made of the packet discard operation in the case where the traffic is made to flow at a flow rate exceeding the maximum usable bandwidth (100 Mbps) of the link aggregation logical port.

When the device 1 receives a packet, the packet reaches the bandwidth measuring unit 13 via the bandwidth allocation control unit 12. The operations performed by each part so far are the same as those in the first and second operational modes and their detailed description will thus be omitted.

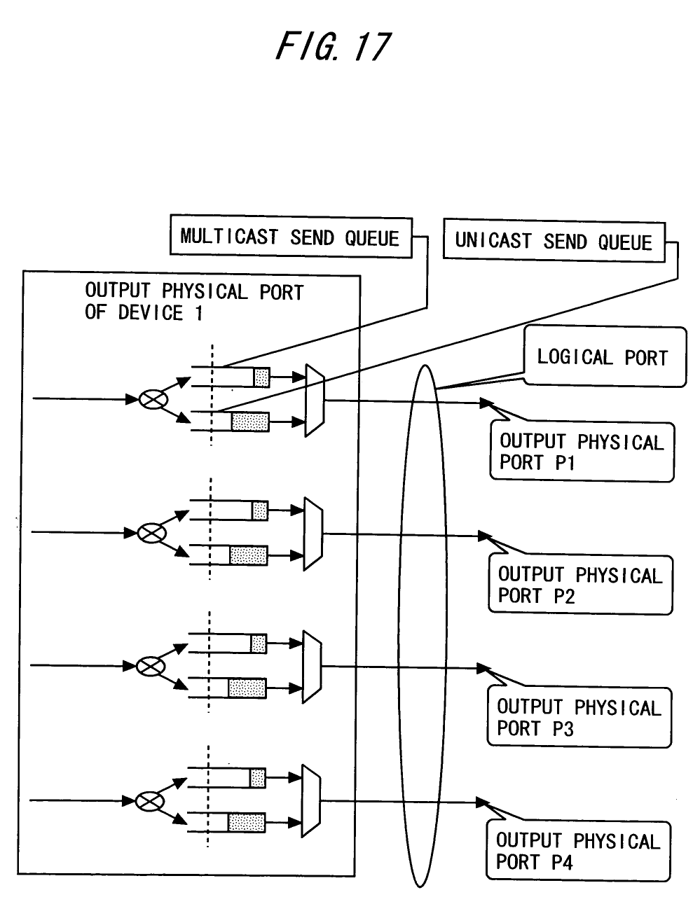

After that, when receiving a receive packet allocated by the bandwidth allocation control unit 12, as shown in FIG. 17, the bandwidth measuring unit 13 reads a destination address DA from the header of the receive packet, and determines whether or not the destination MAC address DA has been learned. If the DA has not been learned, the bandwidth measuring unit 13 puts the receive packet into the multicast send queue, and if the DA has been learned, the bandwidth measuring unit 13 puts the receive packet into the unicast send queue. The packets put into those queues are sequentially outputted to the output physical port number “P3”.

Note that for the description of the third operational mode, it is assumed that the total output flow rates (measured bandwidths) of the unicast packets and multicast packets from the device 1 are 50 Mbps, 40 Mbps, 30 Mbps, and 20 Mbps for P1, P2, P3, and P4, respectively, and the output bandwidth for the multicast packets is 0 Mbps.

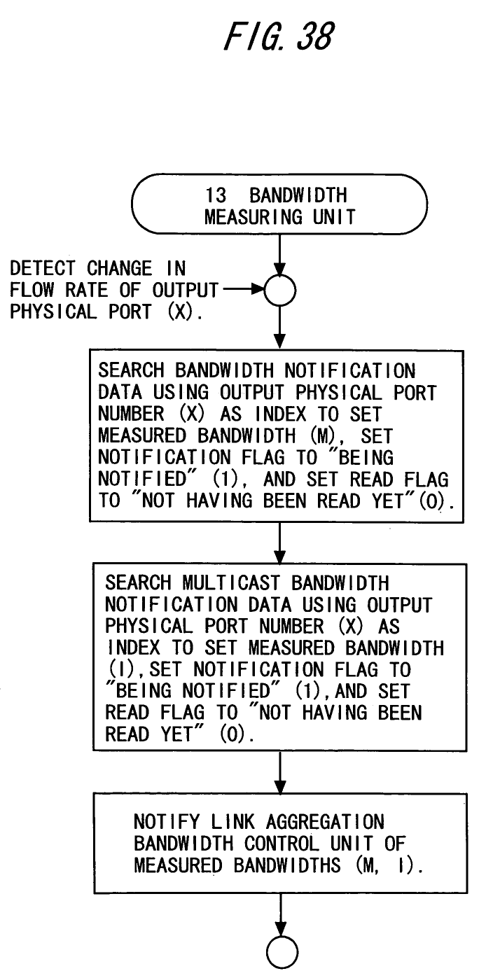

As shown in a process flow of FIG. 38, if there is a change in the flow rate of the structural output physical port, the bandwidth measuring unit 13 searches the bandwidth notification data (storage area) shown in FIG. 22 using the physical port number (1) as an index, sets the measured bandwidth (50 Mbps), sets the notification flag to “being notified” (1), sets the read flag to “not having been read yet” (0), and notifies the link aggregation bandwidth control unit 14 of the measured bandwidth. With regard to P2, P3, and P4, the bandwidth measuring unit 13 similarly sets the measured bandwidths 40 Mbps, 30 Mbps, and 20 Mbps, respectively, sets the notification flag to “being notified” (1), and sets the read flag to “not having been read yet” (0).

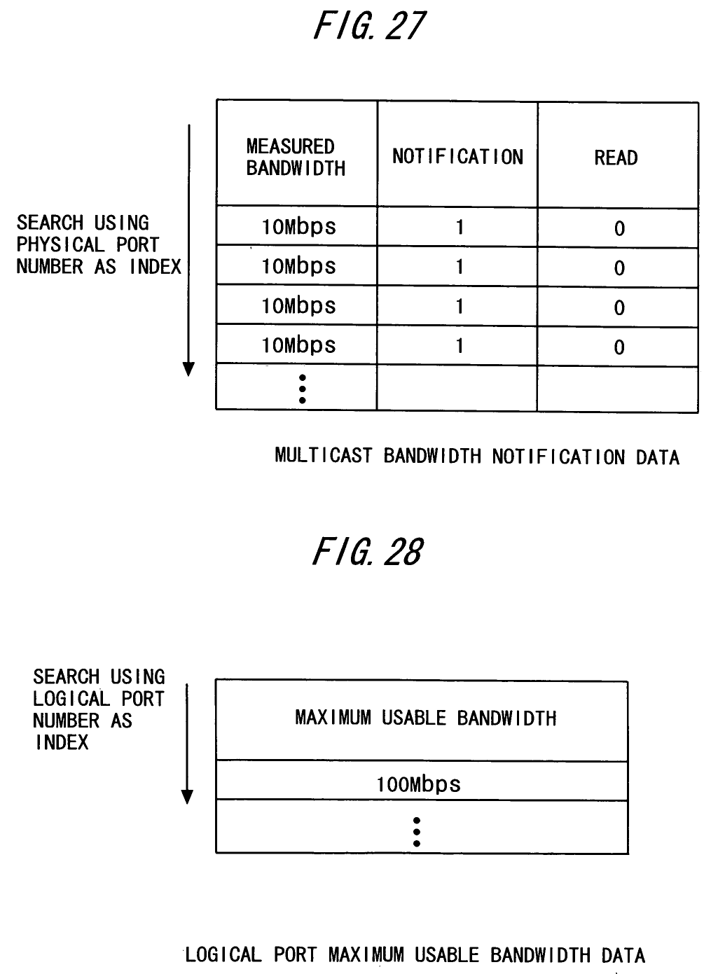

Further, the bandwidth measuring unit 13 searches multicast bandwidth notification data (storage area) shown in FIG. 27 using the physical port number (1) as an index, sets the measured bandwidth (0 Mbps), sets the notification flag to “being notified” (1), and sets the read flag to “not having been read yet” (0). With regard to P2, P3, and P4, the bandwidth measuring unit 13 similarly sets the measured bandwidths 0 Mbps, 0 Mbps, and 0 Mbps, respectively, sets the notification flag to “being notified” (1), sets the read flag to “not having been read yet” (0), and notifies the link aggregation bandwidth control unit 14 of the measured bandwidth for multicasting.

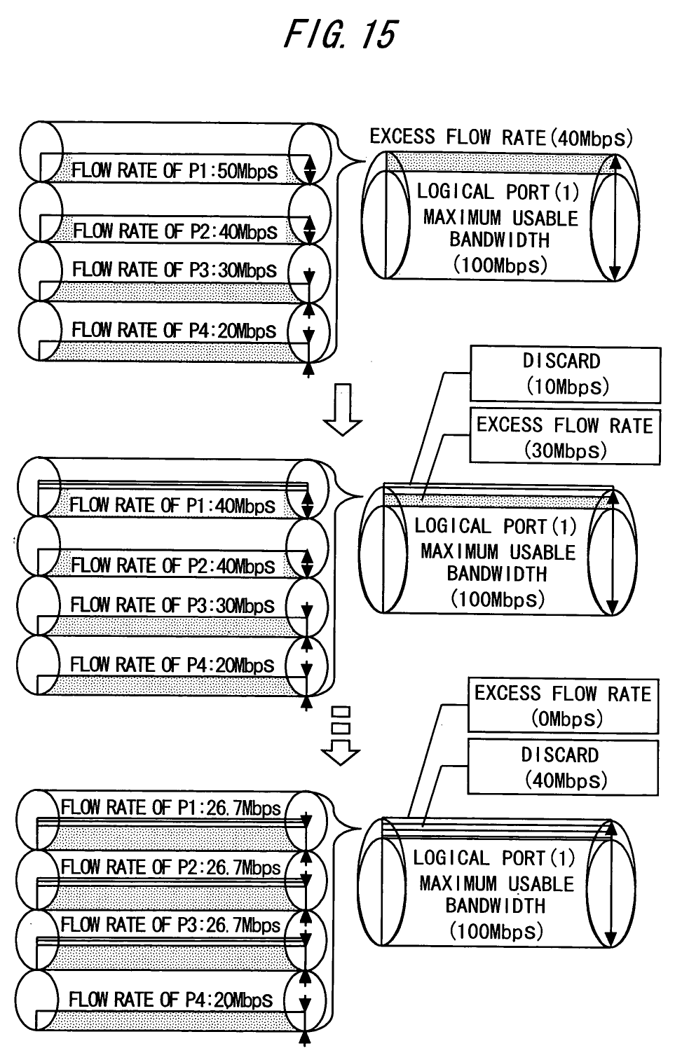

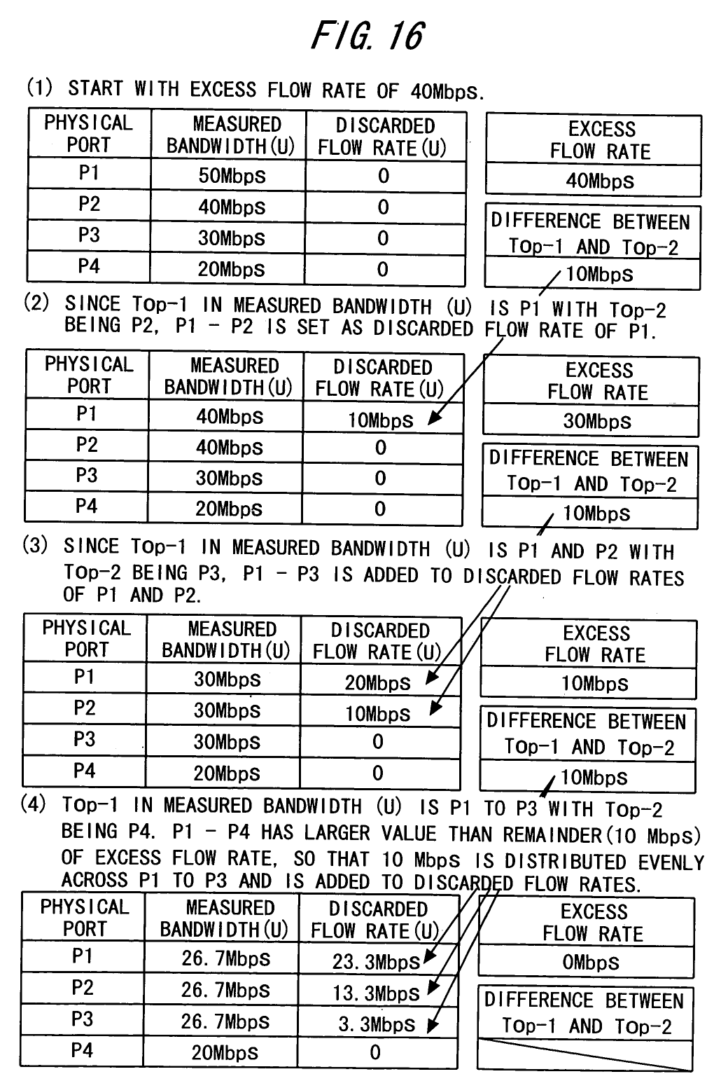

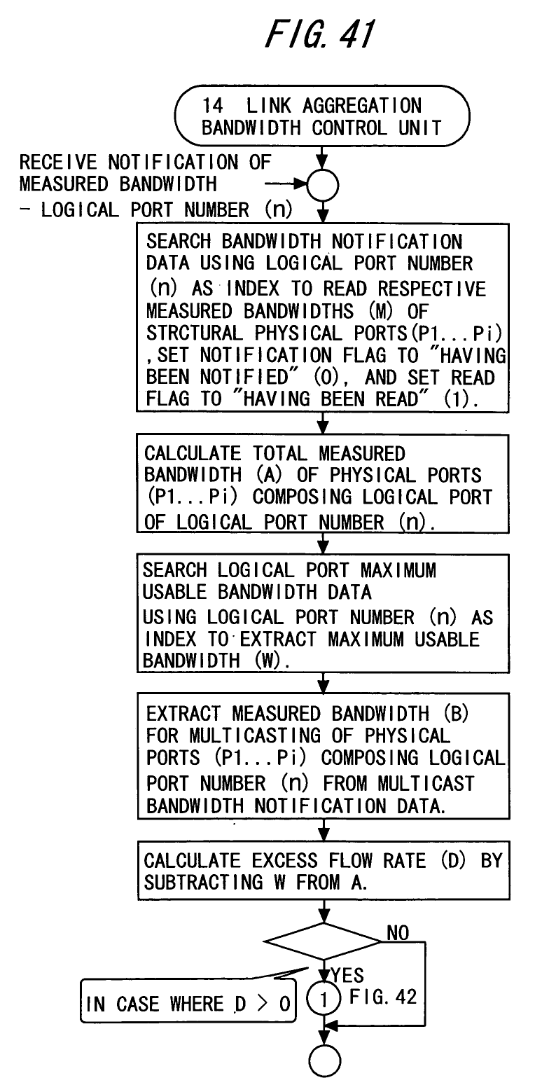

Then, as shown in a process flow of FIG. 41, having been notified of the measured bandwidths, the link aggregation bandwidth control unit 14 compares the total sum of the measured bandwidths, that is, 50+40+30+20=140 Mbps, with the maximum usable bandwidth 100 Mbps, judges that the flow rates are excess (the total sum of the measured bandwidths>the maximum usable bandwidth), and starts calculation of a discarded flow rate such that the discarded ratio is increased for a larger measured bandwidth. With FIG. 15 and FIG. 16 illustrating a calculation process, detailed description will be made hereinbelow.

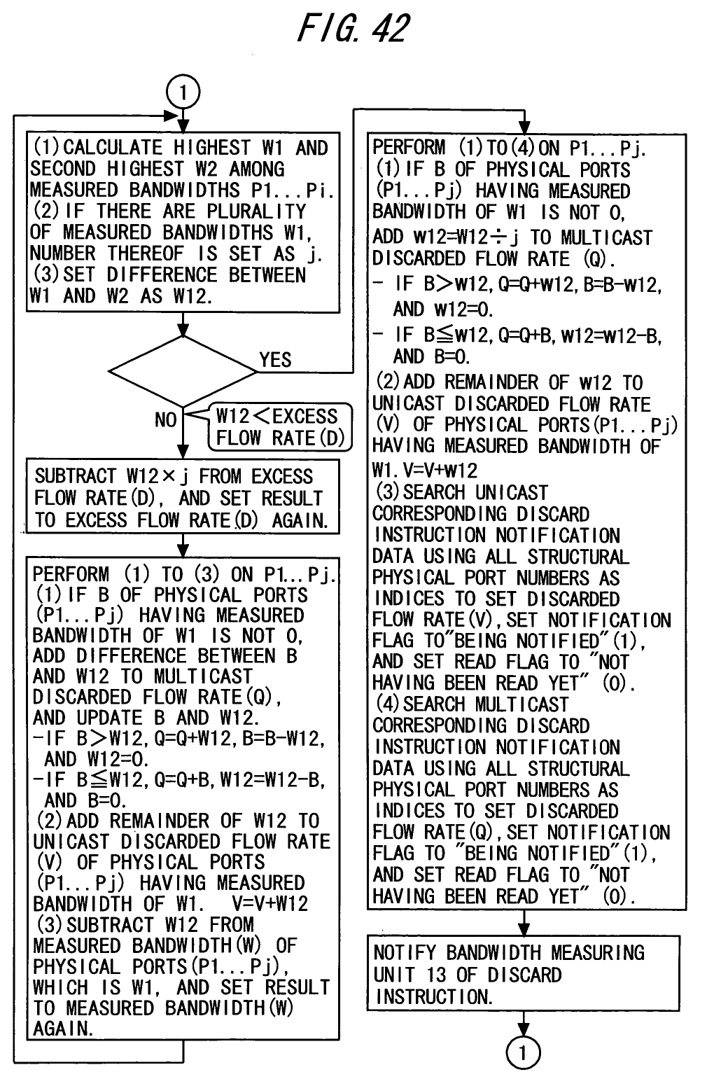

First, as shown in a process flow of FIG. 42, the link aggregation bandwidth control unit 14 extracts the physical ports having the highest measured bandwidth and the second highest measured bandwidth among the structural physical ports, that is, P1: 50 Mbps and P2: 40 Mbps, respectively. The link aggregation bandwidth control unit 14 calculates a measured bandwidth difference between the highest measured bandwidth and the second highest measured bandwidth as 10 Mbps.

According to the process flow of FIG. 42, since the measured bandwidth difference 10 Mbps is lower than the excess flow rate 0 Mbps, the link aggregation bandwidth control unit 14 obtains the remaining excess flow rate 40−10=30 Mbps, the discarded flow rates P1, P2, P3, and P4=10 Mbps, 0 Mbps, 0 Mbps, and 0 Mbps, and the measured bandwidths after discard P1, P2, P3, and P4=40 Mbps, 40 Mbps, 30 Mbps, and 20 Mbps.

The bandwidth control unit 14 extracts again the physical ports having the highest measured bandwidths and the second highest measured bandwidth, that is, P1: 40 Mbps and P2: 40 Mbps, and P3: 30 Mbps. The bandwidth control unit 14 calculates the measured bandwidth difference between the highest measured bandwidths and the second highest measured bandwidth as 10 Mbps.

Further, similarly to the above, since the measured bandwidth difference 10 Mbps is lower than the excess flow rate 30 Mbps, the bandwidth control unit 14 obtains the remaining excess flow rate 30−10×2=10 Mbps, the discarded flow rates P1, P2, P3, and P4=20 Mbps, 10 Mbps, 0 Mbps, and 0 Mbps, and the measured bandwidths after discard P1, P2, P3, and P4=30 Mbps, 30 Mbps, 30 Mbps, and 20 Mbps.

The bandwidth control unit 14 extracts again the physical ports having the highest measured bandwidths and the second highest measured bandwidth, that is, P1: 30 Mbps, P2: 30 Mbps, and P3: 30 Mbps, and P4: 20 Mbps. The bandwidth control unit 14 calculates the measured bandwidth difference between the highest measured bandwidths and the second highest measured bandwidth as 10 Mbps.

According to the process flow of FIG. 42, since the measured bandwidth difference 10 Mbps is equal to or higher than the excess flow rate 10 Mbps, the bandwidth control unit 14 discards the excess flow rate 10 Mbps evenly across P1, P2, and P3, resulting in the discarded flow rates P1, P2, P3, and P4=23.3 Mbps, 13.3 Mbps, 3.3 Mbps, and 0 Mbps. Also, the measured bandwidths after the discard are P1: 26.7 Mbps, P2: 26.7 Mbps, P3: 26.7 Mbps, and P4: 20 Mbps, and the remaining excess flow rate is 0 Mbps, where the calculation ends.

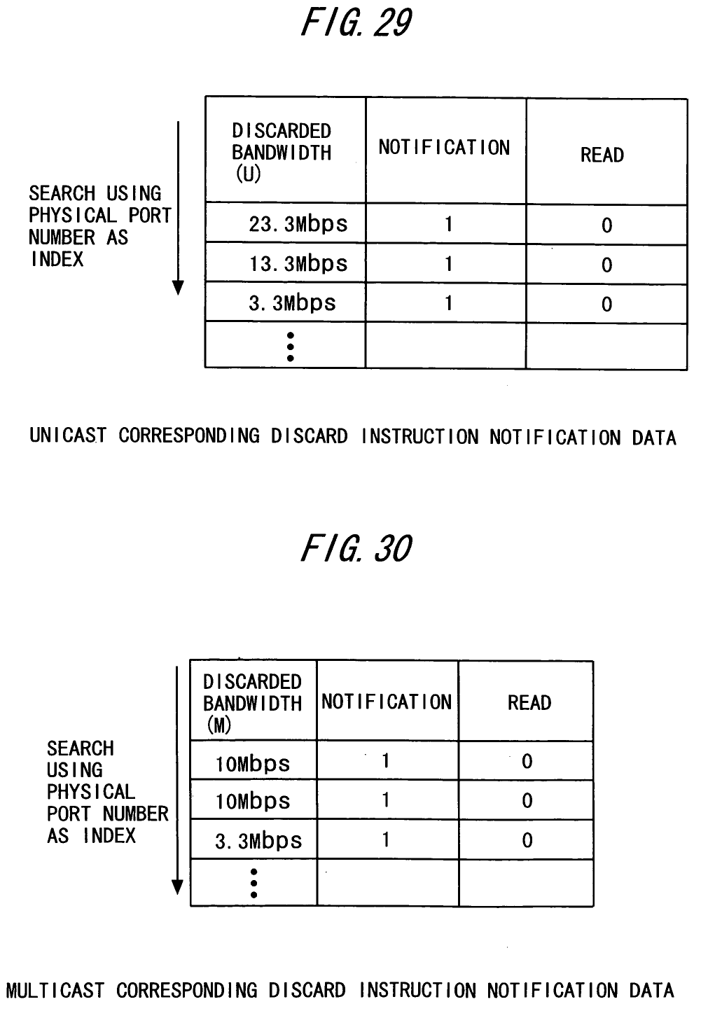

From the calculation results, the link aggregation bandwidth control unit 14 searches unicast corresponding discard instruction notification data (storage area) shown in FIG. 29 using the structural physical port number as an index, sets the discarded flow rates for P1, P2, P3, and P4 to 23.3 Mbps, 13.3 Mbps, 3.3 Mbps, and 0 Mbps, respectively, sets the notification flag to “being notified” (1), sets the read flag to “not having been read yet” (0), and notifies the bandwidth measuring unit 13 of a discard instruction.

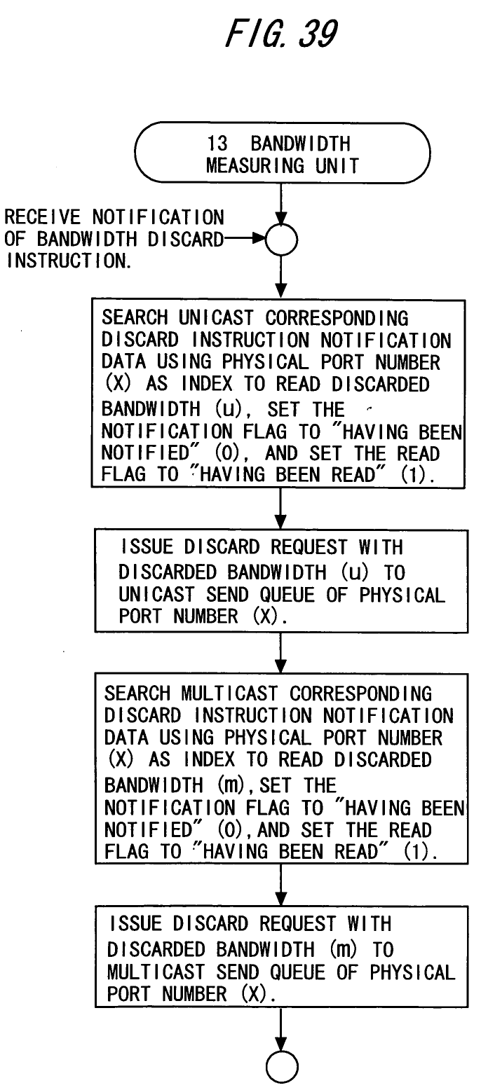

As shown in a process flow of FIG. 39, the bandwidth measuring unit 13 notified of the discard instruction reads the unicast corresponding discard instruction notification data, sets the notification flag to “having been notified” (0), and sets the read flag to “having been read” (1). The bandwidth measuring unit 13 sets the read discard bandwidth in the unicast send queue.

As has been described above, by adopting the third operational mode, the data transmission device 10 can distribute the traffic evenly all across the plurality of physical ports composing the link aggregation within a set QoS bandwidth.

(Fourth Operational Mode)

Next, description will be made of a packet discard operation in the case where a multicast packet exists.

Also described herein is the packet discard operation in the case where the traffic is made to flow at a flow rate exceeding the maximum usable bandwidth (100 Mbps) of the link aggregation logical port. When the device 1 receives a packet, the packet reaches the bandwidth measuring unit 13 via the bandwidth allocation control unit 12 to be outputted to the outside of the device. The processes performed so far are the same as those of the second operational mode and their detailed description will thus be omitted.

Note that for the description of the fourth operational mode, it is assumed that the total measured bandwidths of the unicast packets and multicast packets from the device 1 are 50 Mbps, 40 Mbps, 30 Mbps, and 20 Mbps for P1, P2, P3, and P4, respectively, which include the output bandwidths for the multicast packets are 10 Mbps, 10 Mbps, 10 Mbps, and 10 Mbps, respectively.

As shown in the process flow of FIG. 38, if there is a change in the flow rate of the structural output physical port, the bandwidth measuring unit 13 searches the bandwidth notification data (storage area) shown in FIG. 22 using the physical port number (1) as an index, sets the measured bandwidth 50 Mbps, sets the notification flag to “being notified” (1), sets the read flag to “not having been readyet” (0), and notifies the link aggregation bandwidth control unit 14 of the measured bandwidth. With regard to P2, P3, and P4, the bandwidth measuring unit 13 similarly sets the measured bandwidths 40 Mbps, 30 Mbps, and 20 Mbps, respectively, sets the notification flag to “being notified” (1), and sets the read flag to “not having been read yet” (0).

Further, the bandwidth measuring unit 13 searches the multicast bandwidth notification data (storage area) shown in FIG. 27 using the physical port number (1) as an index, sets the measured bandwidth 10 Mbps, sets the notification flag to “being notified” (1), and sets the read flag to “not having been read yet” (0). With regard to P2, P3, and P4, the bandwidth measuring unit 13 similarly sets the measured bandwidths 10 Mbps, 10 Mbps, and 10 Mbps, respectively, sets the notification flag to “being notified” (1), sets the read flag to “not having been read yet” (0), and notifies the link aggregation bandwidth control unit 14 of the measured bandwidth for multicast packets.

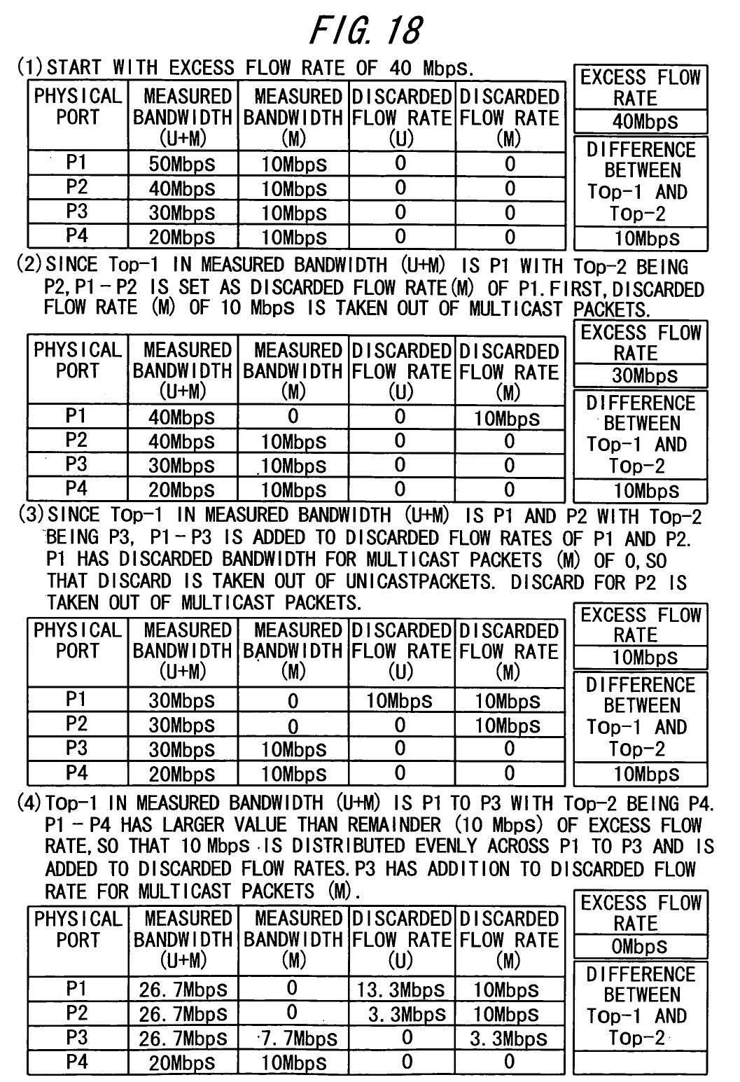

Then, as shown in the process flow of FIG. 41, having been notified of the measured bandwidths by the bandwidth measuring unit 13, the link aggregation bandwidth control unit 14 compares the total sum of the measured bandwidths, that is, 50+40+30+20=140 Mbps, with the maximum usable bandwidth 100 Mbps, judges that the flow rates are excess (the total sum of the measured bandwidths>the maximum usable bandwidth), discards the multicast packets with a high priority, and starts calculation of a discarded flow rate such that the discarded ratio is increased for a larger measured bandwidth. With FIG. 18 illustrating a calculation process, detailed description will be made hereinbelow.

First, as shown in a process flow of FIG. 42, the link aggregation bandwidth control unit 14 extracts the physical ports having the highest measured bandwidth and the second highest measured bandwidth among the structural physical ports, that is, P1: 50 Mbps and P2: 40 Mbps, respectively. The link aggregation bandwidth control unit 14 calculates a measured bandwidth difference between the highest measured bandwidth and the second highest measured bandwidth as 10 Mbps.

According to the process flow of FIG. 42, since the measured bandwidth difference 10 Mbps is lower than the excess flow rate 40 Mbps, the bandwidth control unit 14 obtains the remaining excess flow rate 40−10=30 Mbps, the discarded flow rates for unicast packets being 0 Mbps, 0 Mbps, 0 Mbps, and 0 Mbps, the discarded flow rates for multicast packets being 10 Mbps, 0 Mbps, 0 Mbps, and 0 Mbps, the measured bandwidths after discard P1, P2, P3, and P4=40 Mbps, 40 Mbps, 30 Mbps, and 20 Mbps, and multicast bandwidths after discard P1, P2, P3, and P4=0 Mbps, 10 Mbps, 10 Mbps, and 10 Mbps.

The bandwidth control unit 14 extracts again the physical ports having the highest measured bandwidths and the second highest measured bandwidth, that is, P1: 40 Mbps and P2: 40 Mbps, and P3: 30 Mbps. Based on the extraction results, the bandwidth control unit 14 calculates the measured bandwidth difference between the highest measured bandwidths and the second highest measured bandwidth as 10 Mbps.

Similarly to the above, since the measured bandwidth difference 10 Mbps is lower than the excess flow rate 30 Mbps, the bandwidth control unit 14 obtains the remaining excess flow rate 30−10×2=10 Mbps, the discarded flow rates for unicast packets P1, P2, P3, and P4=10 Mbps, 0 Mbps, 0 Mbps, and 0 Mbps, the discarded flow rates for multicast packets being 10 Mbps, 10 Mbps, 0 Mbps, and 0 Mbps, the measured bandwidths after discard P1, P2, P3, and P4=30 Mbps, 30 Mbps, 30 Mbps, and 20 Mbps, and the multicast bandwidths after discard P1, P2, P3, and P4=0 Mbps, 0 Mbps, 0 Mbps, and 10 Mbps.

The bandwidth control unit 14 extracts again the physical ports having the highest measured bandwidths and the second highest measured bandwidth, that is, P1: 30 Mbps, P2: 30 Mbps, and P3: 30 Mbps, and P4: 20 Mbps. Based on the extraction results, the bandwidth control unit 14 calculates the measured bandwidth difference between the highest measured bandwidths and the second highest measured bandwidth as 10 Mbps.

According to the process flow of FIG. 42, since the measured bandwidth difference 10 Mbps is equal to or higher than the excess flow rate 10 Mbps, the bandwidth control unit 14 discards the excess flow rate 10 Mbps evenly across P1, P2, and P3, resulting in the discarded flow rates for unicast packets P1, P2, P3, and P4=13.3 Mbps, 3.3 Mbps, 0 Mbps, and 0 Mbps, and the discarded flow rates for multicast packets P1, P2, P3, and P4=10 Mbps, 10 Mbps, 3.3 Mbps, and 0 Mbps. Also, the measured bandwidths after the discard for P1, P2, P3, and P4 are 26.7 Mbps, 26.7 Mbps, 26.7 Mbps, and 20 Mbps, respectively, and the multicast measured bandwidths after the discard for P1, P2, P3, and P4 are 0 Mbps, 0 Mbps, 7.3 Mbps, and 10 Mbps, respectively, where the calculation ends.

From the calculation results, the bandwidth control unit 14 searches the unicast corresponding discard instruction notification data (storage area) shown in FIG. 29 and multicast corresponding discard instruction notification data (storage area) shown in FIG. 30 using the structural physical port number as an index, sets the discarded flow rates for unicast packets for P1, P2, P3, and P4 to 13.3 Mbps, 3.3 Mbps, 0 Mbps, and 0 Mbps, respectively, sets the notification flag to “being notified” (1), sets the read flag to “not having been read yet” (0), sets the discarded flow rates for multicast packets for P1, P2, P3, and P4 to 10 Mbps, 10 Mbps, 3.3 Mbps, and 0 Mbps, respectively, sets the notification flag to “being notified” (1), sets the read flag to “not having been read yet” (0), and notifies the bandwidth measuring unit 13 of a discard instruction.

As shown in the process flow of FIG. 39, the bandwidth measuring unit 13 notified of the discard instruction by the link aggregation bandwidth control unit 14 reads the unicast corresponding discard instruction notification data (storage area), sets the notification flag to “having been notified” (0) and sets the read flag to “having been read” (1). The bandwidth measuring unit 13 sets the read discard bandwidth in the unicast send queue.

Also, the bandwidth measuring unit 13 reads the multicast corresponding discard instruction notification data (storage area), sets the notification flag to “having been notified” (0), and sets the read flag to “having been read” (1). The bandwidth measuring unit 13 sets the read discard bandwidth in the multicast send queue.

As has been described above, by adopting the fourth operational mode, the data transmission device 10 can suppress the influence on traffic already in communication to a minimum.

[Modification of First and Second Operational Modes]

As in the case of the first and second operational modes, according to the data transmission device 10 adopting a modified operational mode of the first and second operational modes, the amount (number) of hash values allocated to physical ports is not increased or decreased, but instead, the output flow rate for each hash value is measured, and a combination of the hash values allocated to the physical port is changed to thereby equalize the traffic to be outputted to each physical port.

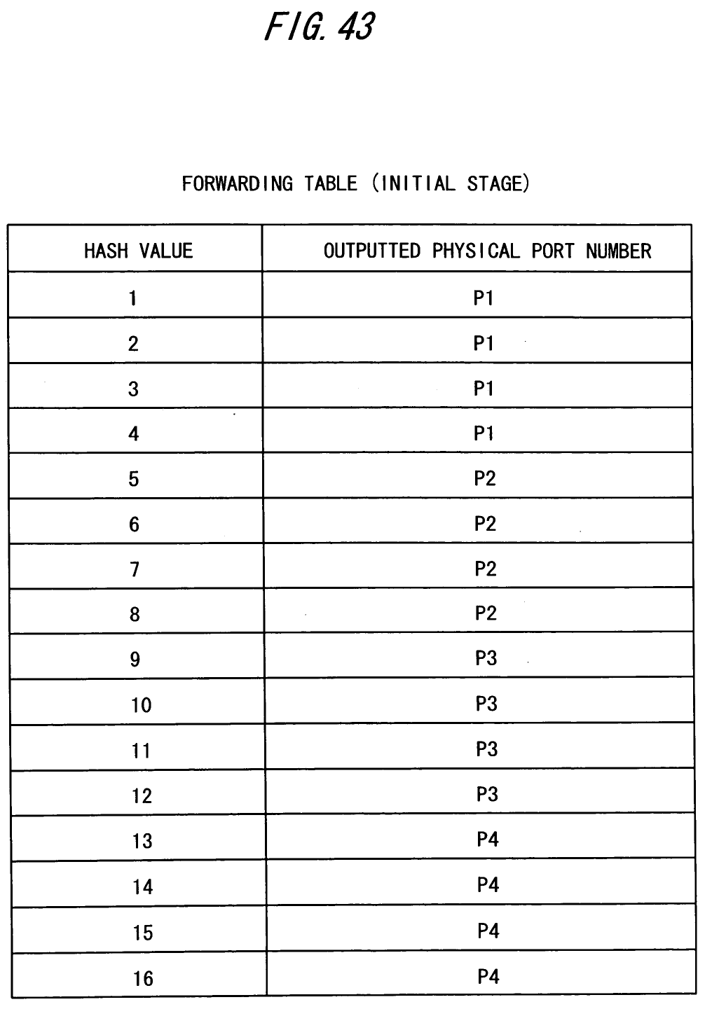

Here, for the simplicity of description, it is assumed that 4 physical ports P1, P2, P3, and P4 are used as the plurality of physical ports composing the link aggregation, and 16 hash values 1 to 16 are used. Further, the data transmission device 10 adopts a configuration shown in FIG. 8, and the forwarding table used initially in the bandwidth allocation control unit 12 is assumed to be that shown in FIG. 43.

First, based on a hash value calculated form a receive packet, the bandwidth allocation control unit 12 searches the forwarding table using an index to determine an output physical port, and forwards the receive packet to the bandwidth measuring unit 13. In order for the bandwidth measuring unit 13 to measure the flow rate for each hash value, the bandwidth allocation control unit 12 forwards adds the used hash value to the packet for the forwarding.

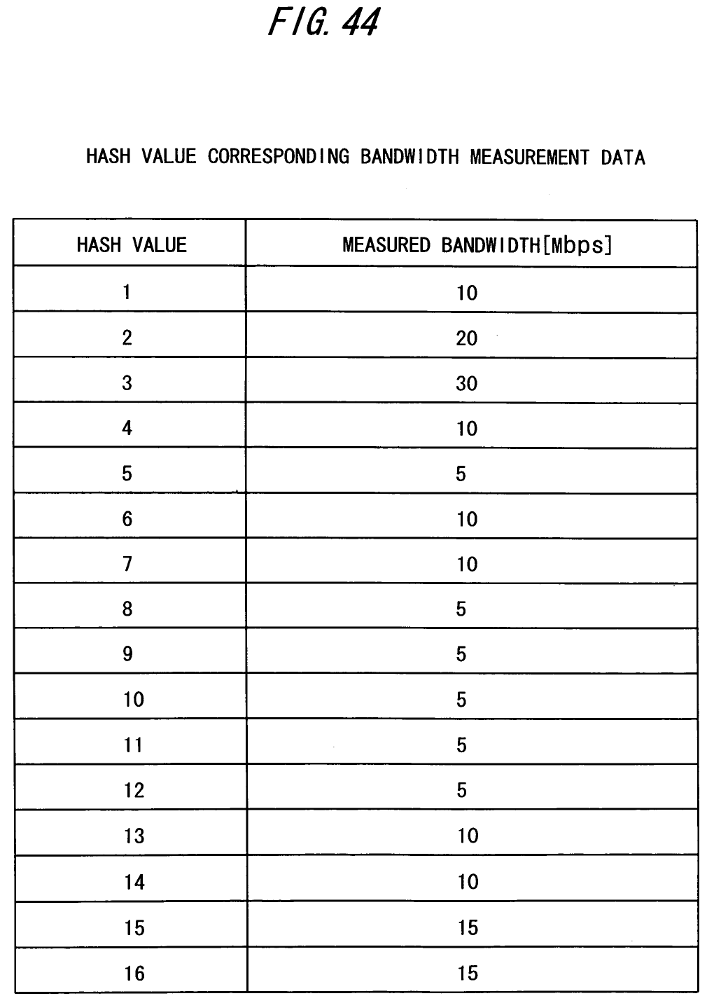

When the receive packet reaches the physical port, instead of measuring a bandwidth (flow rate) of the traffic to be outputted to the physical port, the bandwidth measuring unit 13 measures bandwidth (flow rate) of each physical port, extracts the hash value added to the packet, and measures the bandwidth (flow rate) on a hash value basis. A specific example of bandwidth measurement results (hash value corresponding bandwidth measurement data) is shown in FIG. 44. Also, the bandwidth measuring unit 13 notifies the link aggregation bandwidth control unit 14 of the measurement results.

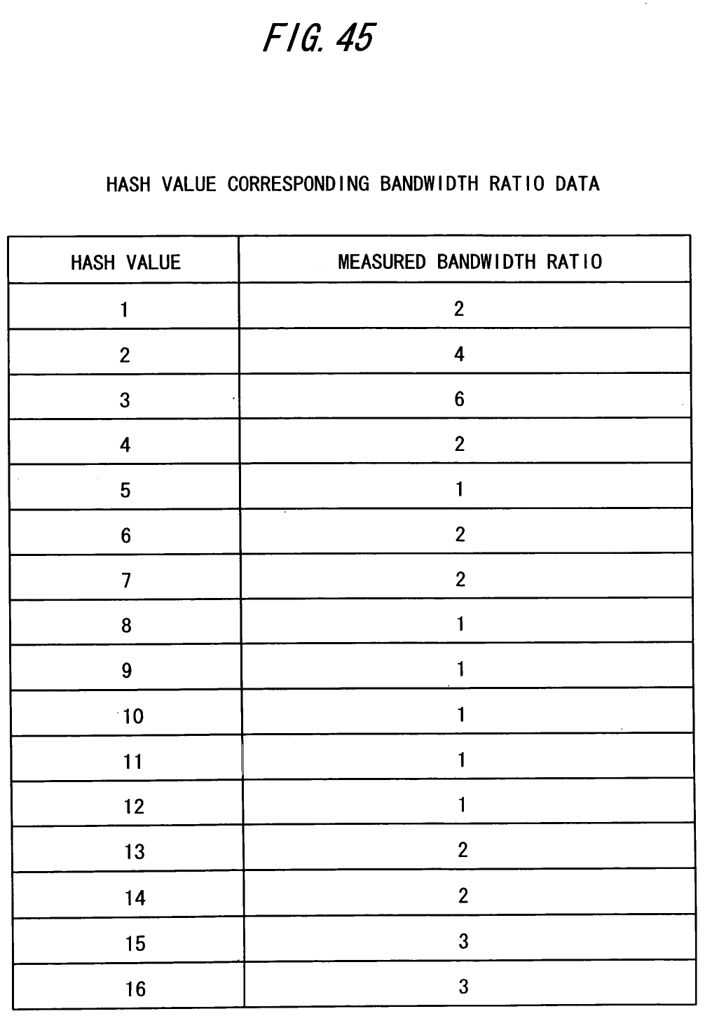

The link aggregation bandwidth control unit 14 reads the measurement results notified of by the bandwidth measuring unit 13, and calculates the integer ratio between the measured bandwidths. A specific example of the bandwidth ratio calculation results (hash value corresponding bandwidth ratio measurement data) is shown in FIG. 45. The link aggregation bandwidth control unit 14 notifies the bandwidth allocation control unit 12 of the hash value corresponding bandwidth ratio measurement data of the bandwidth ratio calculation results.

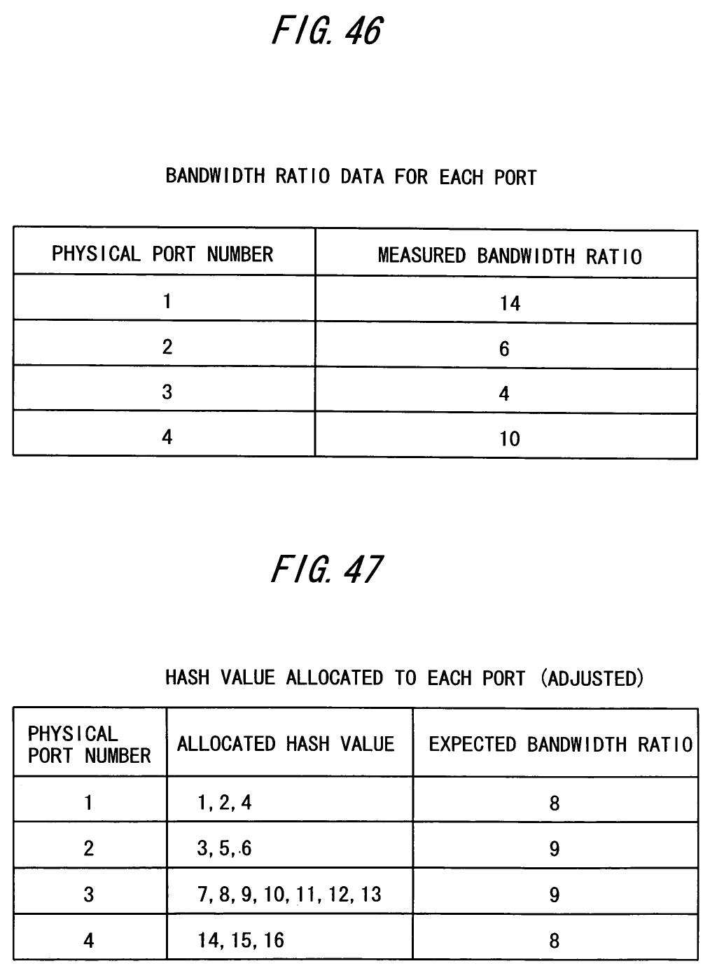

The bandwidth allocation control unit 12 calculates a bandwidth ratio (flow rate ratio) of each port based on the notified bandwidth ratio calculation results. If calculated based on the example of the hash value corresponding bandwidth ratio measurement data shown in FIG. 45, the bandwidth ratio of each port is P1, P2, P3, and P4=14, 6, 4, 10 as shown in FIG. 46.

The bandwidth allocation control unit 12 changes a hash combination to equalize the bandwidth ratio. Since the total sum of distribution ratio values is 14+6+4+10=34, the bandwidth ratio value per physical port is properly 8 or 9. The bandwidth allocation control unit 12 performs calculation so as to obtain such a proper bandwidth ratio.

FIG. 47 shows specific results from adjustment of the hash combination. The bandwidth allocation control unit 12 sets the forwarding table shown in FIG. 43 based on the contents of the hash values allocated to each physical port.

As has been described above, according to the data transmission device 10 adopting the modified operational mode of the first and second operational modes, the combination of hash values allocated to the physical ports is adjusted, thereby making it possible to distribute the traffic evenly all across the plurality of physical ports composing the link aggregation.

### MODIFIED EXAMPLES

The process according to the embodiment described above may be provided as a program executable by a computer, and may be provided by means of a recording medium such as a CD-ROM or a flexible disk or even through a communication line.

In addition, according to the embodiment described above, an arbitrary number or all of the processes may also be combined for execution. For example, the processes may be executed by combining the first and second operational modes with the third and fourth operational modes. In that case, after the process of the discard in the third and fourth operational modes with a high priority is performed, the process of equalized distribution in the first and second operational modes is executed. In consideration for the traffic inputted in the physical ports, which varies as time elapses, there is an advantage of facilitating the more equalized distribution.

### INDUSTRIAL APPLICABILITY

The present invention can be applied to a data transmission device (layer 2 switch device) for a communication carrier that provides a wide-area LAN service etc. on which attentions have been focused in recent years and which requires higher reliability than a LAN within an enterprise in terms of a QoS assurance for connection between LANs of the enterprise. The invention allows bandwidth distribution etc. to be performed evenly (strictly speaking, substantially evenly) across a plurality of physical ports composing a logical port for link aggregation.

1. A traffic distribution control device which, in order to distribute traffic across a plurality of physical ports composing a logical port for link aggregation, uses a hash function to calculate a hash value from a destination address and a source address of a receive packet, and determines a destination physical port, the traffic distribution control device comprising:
a measuring unit measuring an output flow rate of a packet outputted from each of the plurality of physical ports;
a calculating unit calculating a flow rate ratio between the plurality of physical ports with respect to the measured output flow rates; and
a first control unit feeding the calculated flow rate ratio back to a bandwidth distribution ratio between the plurality of physical ports to change numerical allocation of hash values for determining the destination physical port.

2. The traffic distribution control device according to claim 1, wherein, when feeding the flow rate ratio back to the bandwidth distribution ratio, the first control unit uses a bandwidth distribution ratio feedback coefficient to recalculate the numerical allocation of hash values, thereby feeding part of the flow rate ratio back to the bandwidth distribution ratio.

3. The traffic distribution control device according to claim 1, further comprising:
a second control unit requesting, when packet discard is performed on the condition that bandwidth assurance is performed using the logical port for the link aggregation as a unit, the packet discard of a physical port having the highest output flow rate with a high priority in order to equalize output flow rates of the plurality of physical ports.

4. The traffic distribution control device according to claim 3, wherein the second control unit issues a request to discard a broadcast packet with a high priority for discarding a packet exceeding a maximum usable bandwidth.

5. A traffic distribution control device which, in order to distribute traffic across a plurality of physical ports composing a logical port for link aggregation, performs packet discard on the condition that bandwidth assurance is performed using the logical port as a unit, the traffic distribution control device comprising:
a measuring unit measuring output flow rates of packets outputted from each of the plurality of physical ports; and
a control unit calculating an excess amount of a preset maximum usable bandwidth from a difference between a total sum of the measured output flow rates and the maximum usable bandwidth of the logical port, and requests the packet discard of a physical port having the highest output flow rate with a high priority in order to equalize output flow rates of the plurality of physical ports.

6. The traffic distribution control device according to claim 5, wherein the control unit issues a request to discard a broadcast packet with a high priority for discarding a packet exceeding the maximum usable bandwidth.

7. A traffic distribution control device, comprising:
a measuring unit measuring an output flow rate for each hash value for performing traffic distribution;
a calculating unit calculating a flow rate ratio between flow rates measured corresponding to each hash value; and
a control unit, based on the calculated flow rate ratio, adjusting a combination of hash values allocated to a plurality of physical ports configuring link aggregation to equalize traffic.

8. A traffic distribution control method in which, in order to distribute traffic across a plurality of physical ports composing a logical port for link aggregation, a hash function is used to calculate a hash value from a destination address and a source address of a receive packet, and a destination physical port is determined, the traffic distribution control method comprising:
measuring an output flow rate of a packet outputted from each of the plurality of physical ports;
calculating a flow rate ratio between the plurality of physical ports with respect to the measured output flow rates; and
feeding the calculated flow rate ratio back to a bandwidth distribution ratio between the plurality of physical ports to change numerical allocation of hash values for determining the destination physical port.

9. The traffic distribution control method according to claim 8, further comprising:
when feeding the flow rate ratio back to the bandwidth distribution ratio, using a bandwidth distribution ratio feedback coefficient to recalculate the numerical allocation of hash values, thereby feeding part of the flow rate ratio back to the bandwidth distribution ratio.

10. The traffic distribution control method according to claim 8, further comprising:
when packet discard is performed on the condition that bandwidth assurance is performed using the logical port for the link aggregation as a unit, requesting the packet discard of a physical port having the highest output flow rate with a high priority in order to equalize output flow rates of the plurality of physical ports.

11. The traffic distribution control method according to claim 10, further comprising:
issuing a request to discard a broadcast packet with a high priority for discarding a packet exceeding a maximum usable bandwidth.

12. A traffic distribution control method in which, in order to distribute traffic across a plurality of physical ports composing a logical port for link aggregation, packet discard is performed on the condition that bandwidth assurance is performed using the logical port as a unit, the traffic distribution control method comprising:
measuring output flow rates of packets outputted from each of the plurality of physical ports; and
calculating an excess amount of a preset maximum usable bandwidth of the logical port from a difference between a total sum of the measured output flow rates and the maximum usable bandwidth, and requesting the packet discard of a physical port having the highest output flow rate with a high priority in order to equalize output flow rates of the plurality of physical ports.

13. The traffic distribution control method according to claim 12, further comprising:
issuing a request to discard a broadcast packet with a high priority for discarding a packet exceeding the maximum usable bandwidth.

14. A traffic distribution control method, comprising:
measuring an output flow rate for each hash value for performing traffic distribution;
calculating a flow rate ratio between flow rates measured corresponding to each hash value; and
adjusting, based on the calculated flow rate ratio, a combination of hash values allocated to a plurality of physical ports configuring link aggregation to equalize traffic.
